(19) United States
(12) Patent Application Publication
(10) Pub. No.: US 2026/0025603 A1
(43) Pub. Date: Jan. 22, 2026

(54) PHOTOELECTRIC CONVERSION DEVICE AND EQUIPMENT

(71) Applicant: CANON KABUSHIKI KAISHA, Tokyo (JP)

(72) Inventors: SHOJI KONO, Tokyo (JP); KAZUO YAMAZAKI, Kanagawa (JP); SATOSHI KUMAKI, Saitama (JP)

(21) Appl. No.: 19/269,963

(22) Filed: Jul. 15, 2025

(30) Foreign Application Priority Data
Jul. 19, 2024 (JP) 2024-115752

(51) Int. Cl. H04N 25/78; H04N 25/704; H04N 25/772; H04N 25/779

(52) U.S. Cl. CPC H04N 25/78; H04N 25/704; H04N 25/772; H04N 25/779

(57) ABSTRACT

A first scanning circuit is provided for scanning a plurality of pixels in a first mode for outputting an analog signal of a reset level and a first kind of analog signal corresponding to signal charges of both a first photoelectric conversion unit and a second photoelectric conversion unit, and a second mode for outputting an analog signal corresponding to signal charges of the first photoelectric conversion unit in addition to the reset level and the first kind of analog signal. The second scanning circuit performs an additional signal transfer operation so that the number of a first signal transfer operation between a first analog-to-digital conversion period and an analog-to-digital conversion period immediately before the first analog-to-digital conversion period is equal to the number of a second signal transfer operation between the first analog-to-digital conversion period and an analog-to-digital conversion period next to the first analog-to-digital conversion period.

### BACKGROUND

### Field of the Technology

The present disclosure relates to a photoelectric conversion device.

### Description of the Related Art

Japanese Patent Laid-Open No. 2013-211833 describes an imaging device with a phase-difference autofocus function. Each pixel of the imaging device includes a first photoelectric conversion unit and a second photoelectric conversion unit. When the autofocus is performed, a focus is detected based on a phase difference between a pixel signal from the first photoelectric conversion unit and a pixel signal from the second photoelectric conversion unit. In the imaging device disclosed in Japanese Patent Laid-Open No. 2013-211833, a first region in which only imaging is performed and a second region in which autofocusing and imaging are performed are divided, and by reducing a size of the second region, a processing of the autofocusing is reduced to increase an imaging speed.

A reset pixel signal and an imaging pixel signal are output from pixels included in the first region. Each of the two-pixel signals is processed through AD conversion and transferred to a subsequent signal processing circuit. On the other hand, the reset pixel signal, an autofocus pixel signal, and the imaging pixel signal are output from pixels included in the second region. Each of the three-pixel signals is processed through AD conversion and transferred to the subsequent signal processing circuit. A signal transfer operation is performed using a transfer period in which the AD conversion is not performed (a transfer period between the AD conversion and the AD conversion).

However, since the number of pixel signals output from each pixel is different between the first region and the second region, the number of AD conversions and the number of signal transfer operations are also different. Therefore, when the region is changed, the number of the signal transfer operations may be different in the transfer period between the AD conversion and the AD conversion. Here, noise may be included in the pixel signal at the time of the AD conversion due to power supply fluctuation at the time of performing the signal transfer operation. When the number of signal transfer operations is different, pixel signals different in influence of the noise may be generated. In this case, when the noise is removed using the reset pixel signal, there is a possibility that the noise cannot be accurately removed.

### SUMMARY

Therefore, the present disclosure is directed to provide a photoelectric conversion device capable of accurately removing noise.

According to one disclosure of the present specification, there is provided a photoelectric conversion device including: a plurality of pixels each including a first photoelectric conversion unit and a second photoelectric conversion unit each of which generates a signal charge; a first scanning circuit configured to scan the plurality of pixels in a first mode for outputting an analog signal of a reset level and an analog signal corresponding to the signal charges of both the first photoelectric conversion unit and the second photoelectric conversion unit from the pixel, and a second mode for outputting the analog signal of the reset level, an analog signal corresponding to the signal charge of the first photoelectric conversion unit, and the analog signal corresponding to the signal charges of both the first photoelectric conversion unit and the second photoelectric conversion unit from the pixel; an analog-to-digital conversion unit configured to convert each of analog signals into a digital signal in a plurality of analog-to-digital conversion periods; a memory configured to hold the digital signal; and a second scanning circuit configured to perform a signal transfer operation for outputting the digital signal from the memory in each of a plurality of transfer periods different from the plurality of analog-to-digital conversion periods, wherein the plurality of analog-to-digital conversion periods include a first analog-to-digital conversion period for converting the analog signal of the reset level in the first mode into the digital signal, and wherein when transitioning from the second mode to the first mode, the second scanning circuit performs an additional signal transfer operation so that the number of times of a first signal transfer operation between the first analog-to-digital conversion period and the analog-to-digital conversion period immediately before the first analog-to-digital conversion period is equal to the number of times of a second signal transfer operation between the first analog-to-digital conversion period and the analog-to-digital conversion period next to the first analog-to-digital conversion period.

According to one disclosure of the present specification, there is provided a photoelectric conversion device including: a plurality of pixels each including a first photoelectric conversion unit and a second photoelectric conversion unit each of which generates a signal charge; a first scanning circuit configured to scan the plurality of pixels in a first mode for outputting an analog signal of a reset level and an analog signal corresponding to the signal charges of both the first photoelectric conversion unit and the second photoelectric conversion unit from the pixel, and a second mode for outputting the analog signal of the reset level, an analog signal corresponding to the signal charge of the first photoelectric conversion unit, and the analog signal corresponding to the signal charges of both the first photoelectric conversion unit and the second photoelectric conversion unit from the pixel; an analog-to-digital conversion unit configured to convert each of analog signals into a digital signal in a plurality of analog-to-digital conversion periods; a memory configured to hold the digital signal; and a second scanning circuit configured to perform a signal transfer operation for outputting the digital signal from the memory in each of a plurality of transfer periods different from the plurality of analog-to-digital conversion periods, wherein the plurality of analog-to-digital conversion periods include a first analog-to-digital conversion period for converting the analog signal of the reset level in the first mode into the digital signal, and wherein when transitioning from the second mode to the first mode, the second scanning circuit performs an additional signal transfer operation so that the number of times of a first signal transfer operation between the first analog-to-digital conversion period and the analog-to-digital conversion period immediately before the first analog-to-digital conversion period is the same for each scan in the first mode.

According to one disclosure of the present specification, there is provided a photoelectric conversion device including: a plurality of pixels each including a first photoelectric conversion unit and a second photoelectric conversion unit each of which generates a signal charge; a first scanning circuit configured to scan the plurality of pixels in a first mode for outputting an analog signal of a reset level and an analog signal corresponding to the signal charges of both the first photoelectric conversion unit and the second photoelectric conversion unit from the pixel, and a second mode for outputting the analog signal of the reset level, an analog signal corresponding to the signal charge of the first photoelectric conversion unit, and the analog signal corresponding to the signal charges of both the first photoelectric conversion unit and the second photoelectric conversion unit from the pixel; an analog-to-digital conversion unit configured to convert each of analog signals into a digital signal in a plurality of analog-to-digital conversion periods; a memory configured to hold the digital signal; and a second scanning circuit configured to perform a signal transfer operation for outputting the digital signal from the memory in each of a plurality of transfer periods different from the plurality of analog-to-digital conversion periods, wherein the plurality of analog-to-digital conversion periods include a first analog-to-digital conversion period for converting the analog signal of the reset level in the first mode into the digital signal, and wherein when transitioning from the second mode to the first mode, the second scanning circuit performs an additional signal transfer operation so that the number of times of a first signal transfer operation between the first analog-to-digital conversion period and the analog-to-digital conversion period next to the first analog-to-digital conversion period is the same for each scan in the first mode.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram of an imaging device according to a first embodiment.

FIG. 2 is a circuit diagram of a pixel according to the first embodiment.

FIG. 3 is a timing chart of an imaging device according to a first comparative example.

FIG. 4 is a timing chart of an imaging device according to a second comparative example.

FIG. 5 is a timing chart of an imaging device according to a third comparative example.

FIG. 6 is a timing chart of an imaging device according to a fourth comparative example.

FIG. 7 is a timing chart of the imaging device according to the first embodiment.

FIG. 8 is a timing chart of an imaging device according to a second embodiment.

FIG. 9 is a timing chart of an imaging device according to a fifth comparative example.

FIG. 10 is a timing chart of an imaging device according to a third embodiment.

FIG. 11 is a timing chart of an imaging device according to a fourth embodiment.

FIG. 12 is a block diagram of an equipment according to a fifth embodiment.

FIGS. 13A and 13B are block diagrams of an equipment according to a sixth embodiment.

### DESCRIPTION OF THE EMBODIMENTS

Preferred embodiments of the present invention will now be described in detail in accordance with the accompanying drawings.

In each of the embodiments described below, an imaging device will be mainly described as an example of a photoelectric conversion device. However, each embodiment is not limited to an imaging device and can be applied to other examples of the photoelectric conversion device. For example, there are a ranging device (a device of distance measurement using focus detection or TOF (Time Of Flight)) and a photometric device (a device for measuring an amount of incident light).

### First Embodiment

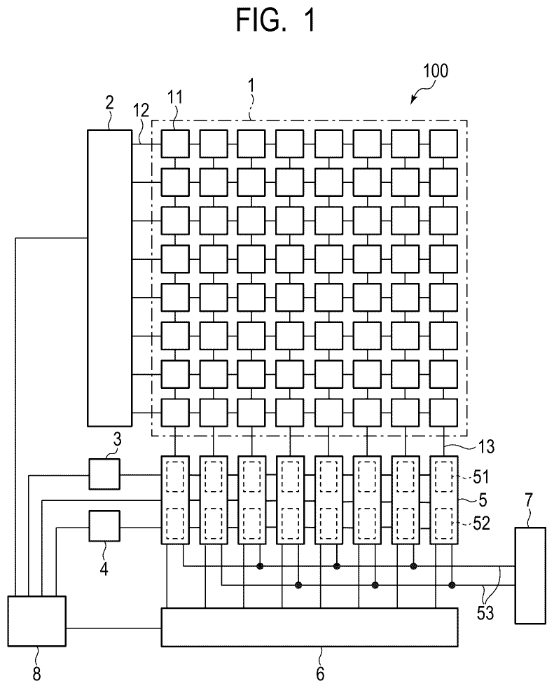

FIG. 1 is a block diagram of an imaging device 100 according to the present embodiment.

The imaging device 100 includes a pixel array 1, a vertical scanning circuit (first scanning circuit) 2, a reference signal output circuit 3, a counter 4, a plurality of column signal processing circuits 5, a horizontal scanning circuit (second scanning circuit) 6, a signal processing circuit 7, and a timing control unit 8.

The pixel array 1 is connected to the vertical scanning circuit 2 and the column signal processing circuits 5. The column signal processing circuits 5 are connected to the reference signal output circuit 3, the counter 4, the horizontal scanning circuit 6, and the signal processing circuit 7. The timing control unit 8 is connected to the vertical scanning circuit 2, the reference signal output circuit 3, the counter 4, the column signal processing circuits 5, and the horizontal scanning circuit 6.

The pixel array 1 is provided with a plurality of pixels 11 arranged in an array to form a plurality of rows and a plurality of columns. The number of pixels 11 constituting the pixel array 1 is not particularly limited. For example, the pixel array 1 can be configured by a plurality of pixels 11 arranged in an array of several thousand rows by several thousand columns as in a general digital camera. Alternatively, the pixel array 1 may include a plurality of pixels 11 arranged in one row or one column. In this specification, the vertical scanning circuit 2 as a first scanning circuit performs scanning to select the pixels for each row, but the first scanning circuit may be a circuit for scanning the pixels for each column.

Each row of the pixel array 1 is provided with a control line 12 extending in a first direction (lateral direction in FIG. 1). The control lines 12 are connected to the pixels 11 arranged in the first direction, and form signal lines common to the pixels 11. The pixels 11 arranged in the same row are controlled by the same control line 12. Each of the control lines 12 may include a plurality of signal lines for supplying a plurality of types of control signals to the pixels 11. The control line 12 of each row is connected to the vertical scanning circuit 2.

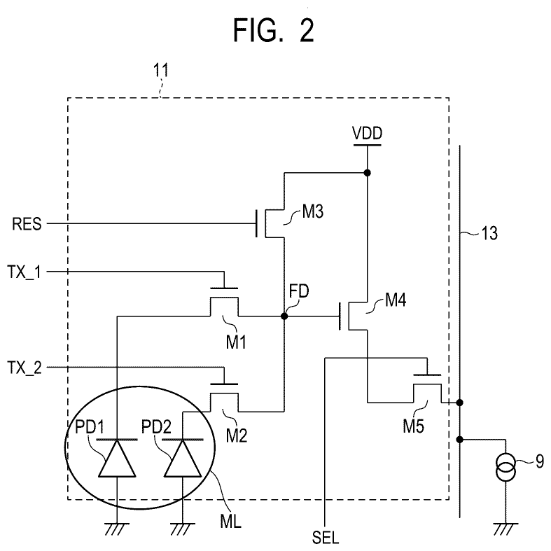

In each column of the pixel array 1, a column signal line 13 is arranged to extend in a second direction (vertical direction in FIG. 1) intersecting the first direction. The column signal lines 13 are connected to the pixels 11 arranged in the second direction, respectively, and form signal lines common to the pixels 11. The column signal line 13 may include a plurality of signal lines for transferring signals output from the pixels 11. The column signal line 13 of each column is connected to each of the column signal processing circuits 5. Each pixel 11 converts incident light into an electrical signal, and outputs the converted electrical signal to the column signal processing circuit 5 via the column signal line 13. More specifically, each pixel 11 outputs a reset signal (analog signal of reset level) before transferring a signal charge by the photoelectric conversion unit and a pixel signal based on the signal charge by the photoelectric conversion unit. The circuit configuration of the pixel 11 will be described later with reference to FIG. 2.

The vertical scanning circuit 2 receives a control signal output from the timing control unit 8, generates a control signal for driving the pixels 11, and supplies the control signal to the pixels 11 via the control line 12. The vertical scanning circuit 2 may include a logic circuit such as a shift register and an address decoder. The vertical scanning circuit 2 sequentially scans the pixels 11 in the pixel array 1 for each row and causes the pixels 11 to output the pixel signals to each of the column signal processing circuits 5 via the column signal line 13, thereby acquiring an image of one frame.

The reference signal output circuit 3 outputs a reference signal (ramp signal) whose voltage changes with time to each of the column signal processing circuits 5.

The counter 4 outputs a count value obtained by counting a clock signal to each of the column signal processing circuits 5.

Each of the column signal processing circuits 5 is disposed for each column signal line 13 and includes a comparator 51 and a memory 52. When the first scanning circuit is configured to select the pixels for each column, the column signal processing circuit 5 may be a row signal processing circuit provided corresponding to a row of pixels.

The comparator 51 compares a voltage of the reference signal from the reference signal output circuit 3 with the voltage of the pixel signal from the pixel 11 and changes a level of an output signal when a magnitude relationship between these voltages is inverted. When the level of the output signal from the comparator 51 changes, the column signal processing circuit 5 writes a count value into the memory 52. The count value is obtained by counting from a point in time when a voltage change of the reference signal starts to a point in time when a level of the output signal from the comparator 51 changes. As a result, AD (analog-to-digital) conversion for converting an analog signal into a digital signal is performed. A count value of the reset signal is written into the memory 52 in the same manner as the pixel signal. The reference signal output circuit 3, the counter 4, and the column signal processing circuit 5 constitute an AD conversion unit.

The memory 52 holds a digital signal (count value). The memory 52 includes a plurality of unit memories and holds count values of the reset signal and the pixel signal.

The horizontal scanning circuit 6 receives a control signal output from the timing control unit 8 and causes the memory 52 to output a digital signal held in the memory 52. The horizontal scanning circuit 6 may include a logic circuit such as a shift register and an address decoder. The horizontal scanning circuit 6 sequentially scans each of the plurality of memories 52 and causes the memories 52 to output the count values of the reset signal and the pixel signal held in each of the memories 52 to the signal processing circuit 7 via the common signal line 53. In the case of a configuration in which the column signal processing circuit 5 is modified into a row signal processing circuit provided corresponding to a row of pixels, the horizontal scanning circuit 6 can be a scanning circuit that scans the row signal processing circuit for each row.

The signal processing circuit 7 processes the digital signal. The signal processing circuit 7 extracts only a signal corresponding to an amount of incident light by subtracting the count value of the reset signal from the count value of the pixel signal, and outputs the extracted signal to an outside of the imaging device 100.

The timing control unit 8 controls an operation and a timing of each constituent element. The timing control unit 8 generates control signals for controlling operations and timings of the vertical scanning circuit 2, the reference signal output circuit 3, the counter 4, the column signal processing circuits 5, and the horizontal scanning circuit 6, and supplies the generated control signals to these constituent elements. The timing control unit 8 may include various electronic components such as a CPU and a memory.

FIG. 2 is a circuit diagram of the pixel 11 according to the present embodiment. The pixel 11 includes a photoelectric conversion element (first photoelectric conversion unit) PD1, a photoelectric conversion element (second photoelectric conversion unit) PD2, transfer transistors M1 and M2, a reset transistor M3, an amplification transistor M4, and a selection transistor M5. The photoelectric conversion elements PD1 and PD2 are provided corresponding to one microlens ML. Light transmitted through the common microlens ML is incident on the photoelectric conversion elements PD1 and PD2. Light transmitted through a partial region of an exit pupil enters the photoelectric conversion element PD1, and light transmitted through another partial region of the exit pupil enters the photoelectric conversion element PD2. Accordingly, it is possible to perform focus detection by a phase difference detection method using a signal corresponding to a signal charge generated by the photoelectric conversion element PD1 and a signal corresponding to a signal charge generated by the photoelectric conversion element PD2.

The present embodiment will be described on an assumption that an electron among electron-hole pairs generated in the photoelectric conversion elements PD1 and PD2 by light incidence is used as a signal charge. When the electron is used as the signal charge, each transistor constituting the pixel 11 may be formed of an N-type MOS transistor. In the case where each transistor is formed of an N-type MOS transistor, when a high-level control signal is supplied from the vertical scanning circuit 2, the transistor to be controlled is turned on. When a low-level control signal is supplied from the vertical scanning circuit 2, the transistor to be controlled is turned off. However, the signal charge is not limited to the electron, and a hole may be used as the signal charge. When the hole is used as the signal charge, a conductivity type of each transistor is opposite to that described in the present embodiment. The names of a source and a drain of the MOS transistor may vary depending on a conductivity type of the transistor or a focusing function. Some or all of the names of the source and the drain used in the present embodiment may be referred to as reverse names.

The photoelectric conversion element PD1 may be a photodiode that accumulates a signal charge according to incident light. An anode of the photoelectric conversion element PD1 is connected to a ground node, and a cathode of the photoelectric conversion element PD1 is connected to a source of the transfer transistor M1. A drain of the transfer transistor M1 is connected to a source of the reset transistor M3 and a gate of the amplification transistor M4.

The photoelectric conversion element PD2 may be a photodiode that accumulates a signal charge according to incident light. An anode of the photoelectric conversion element PD2 is connected to the ground node, and a cathode of the photoelectric conversion element PD2 is connected to a source of the transfer transistor M2. A drain of the transfer transistor M2 is connected to the source of the reset transistor M3 and the gate of the amplification transistor M4. In the present embodiment, two photoelectric conversion elements are provided for one microlens ML, without being limited to this embodiment, and three or more photoelectric conversion elements may be provided for one microlens ML. For example, four photoelectric conversion elements arranged in two rows and two columns may be provided for one microlens ML. In this case, focus detection pixel signals are corresponding to the signal charges of only a part of the four photoelectric conversion elements and is typically corresponding to the signal charges of the photoelectric conversion elements of one row and two columns or two rows and one column. An imaging signal is corresponding to all the signal charges of the four photoelectric conversion elements.

The input node FD to which the drains of the transfer transistors M1 and M2, the source of the reset transistor M3, and the gate of the amplification transistor M4 are connected is a so-called floating diffusion portion. The floating diffusion portion includes a capacitance component (floating diffusion capacitance) and has a function as a charge holding portion that holds a signal charge. The floating diffusion capacitance may include a PN junction capacitance, a wiring capacitance, and the like.

A drain of the reset transistor M3 and a drain of the amplification transistor M4 are connected to a power supply voltage node that supplies a voltage VDD. A source of the amplification transistor M4 is connected to a drain of the selection transistor M5. A source of the selection transistor M5 is connected to the column signal line 13. A current source 9 is connected to the column signal line 13. The current source 9 supplies a bias current to the amplification transistor M4 via the column signal line 13.

In the pixel 11 configured as described above, the control signal TX_1 from the vertical scanning circuit 2 is supplied to a gate of the transfer transistor M1. When the control signal TX_1 is at a high level, the transfer transistor M1 is turned on, and when the control signal TX_1 is at a low level, the transfer transistor M1 is turned off.

The control signal TX_2 from the vertical scanning circuit 2 is supplied to a gate of the transfer transistor M2. When the control signal TX_2 is at a high level, the transfer transistor M2 is turned on, and when the control signal TX_2 is at a low level, the transfer transistor M2 is turned off.

The control signal RES from the vertical scanning circuit 2 is supplied to a gate of the reset transistor M3. When the control signal RES is at a high level, the reset transistor M3 is turned on, and when the control signal RES is at a low level, the reset transistor M3 is turned off.

The control signal SEL from the vertical scanning circuit 2 is supplied to a gate of the selection transistor M5. When the control signal SEL is at a high level, the selection transistor M5 is turned on, and when the control signal SEL is at a low level, the selection transistor M5 is turned off.

The photoelectric conversion element PD1 converts (photoelectrically converts) the incident light into an amount of a signal charge corresponding to an amount of the incident light. The transfer transistor M1 is turned on and transfers the signal charge held by the photoelectric conversion element PD1 to the input node FD. The signal charge transferred from the photoelectric conversion element PD1 is held in the capacitance (floating diffusion capacitance) of the input node FD.

The photoelectric conversion element PD2 converts (photoelectrically converts) the incident light into the amount of the signal charge corresponding to the amount of the incident light. The transfer transistor M2 is turned on and transfers the signal charge held by the photoelectric conversion element PD2 to the input node FD. The signal charge transferred from the photoelectric conversion element PD2 is held in the capacitance (floating diffusion capacitance) of the input node FD.

When the signal charge is transferred only from the photoelectric conversion element PD1 among the photoelectric conversion elements PD1 and PD2, the input node FD becomes a potential corresponding to the amount of the signal charge transferred from the photoelectric conversion element PD1 by charge-voltage conversion by the floating diffusion capacitance. In this case, the pixel signal corresponding to the potential of the input node FD is a focus detection pixel signal used when the focus is detected.

When the signal charges are transferred from both of the photoelectric conversion elements PD1 and PD2, the input node FD becomes a potential corresponding to the amount of the signal charges transferred from both of the photoelectric conversion elements PD1 and PD2 by charge-voltage conversion by the floating diffusion capacitance. In this case, the pixel signal corresponding to the potential of the input node FD becomes an imaging pixel signal that is used when capturing an image.

The reset transistor M3 supplies a voltage (voltage VDD) for resetting to the input node FD. The reset transistor M3 is turned on and resets the input node FD to a voltage corresponding to the voltage VDD.

The selection transistor M5 selectively connects the pixel 11 in the row to be read out among the pixels 11 constituting the pixel array 1 to the column signal line 13. The selection transistor M5 is turned on and connects the amplification transistor M4 of the pixel 11 in the row to be read to the column signal line 13.

In the amplification transistor M4, the voltage VDD is supplied to the drain, and the bias current is supplied to the source from the current source 9 via the selection transistor M5. The amplification transistor M4 constitutes an amplification circuit (source follower circuit) having a gate as the input node FD. The amplification transistor M4 outputs a signal based on the signal charge of the input node FD to the column signal line 13 via the selection transistor M5. In this sense, the amplification transistor M4 and the selection transistor M5 constitute an output unit that outputs the pixel signal corresponding to the amount of signal charges held in the input node FD.

As described above, the pixel 11 can output the reset signal corresponding to the signal level obtained by resetting the potential of the input node FD by the reset transistor M3. The pixel 11 can output the focus detection pixel signal based on the signal charge generated by photoelectric conversion performed by the photoelectric conversion element PD1. The pixel 11 can output the imaging pixel signal based on the signal charges generated by photoelectric conversion performed by the photoelectric conversion elements PD1 and PD2.

By subtracting the focus detection pixel signal (the photoelectric conversion element PD1) from the imaging pixel signal, it is possible to obtain the focus detection pixel signal based on the signal charge generated by the photoelectric conversion performed by the photoelectric conversion element PD2. Then, the focus can be obtained based on the phase difference between the focus detection pixel signal from the photoelectric conversion element PD1 and the focus detection pixel signal from the photoelectric conversion element PD2.

A mode in which the reset signal and the imaging pixel signal are output is referred to as an imaging mode (first mode). A mode in which the reset signal, the focus detection pixel signal, and the imaging pixel signal are output is referred to as an AF imaging mode (second mode). The vertical scanning circuit 2 intermittently scans in the AF imaging mode during scanning in the imaging mode.

Next, before an operation of the imaging device 100 according to the present embodiment, an operation of an imaging device according to a comparative example will be described.

### First Comparative Example

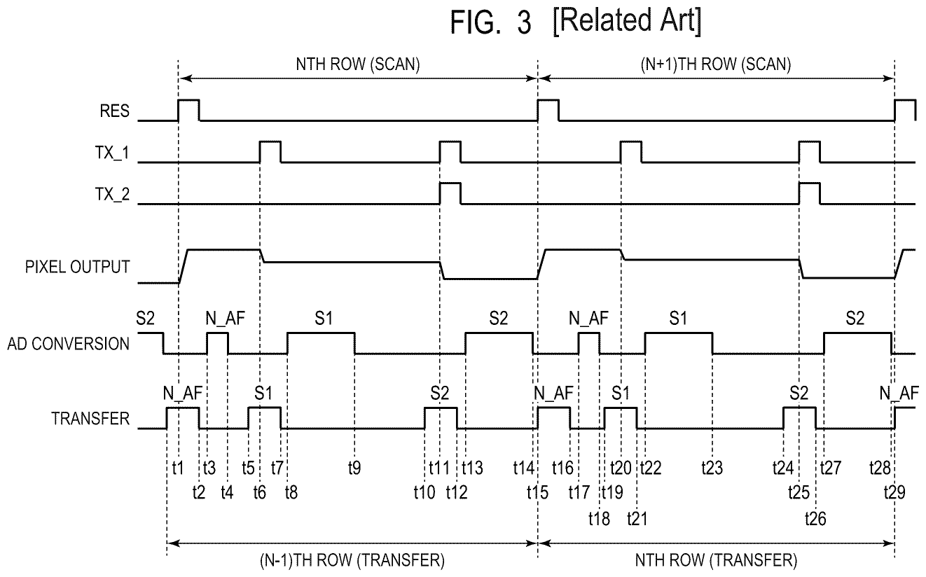

FIG. 3 is a timing chart of the imaging device according to the first comparative example. In FIG. 3, an example in which scanning is performed in the AF imaging mode in the Nth row and the (N+1)th row will be described.

At time t1, the vertical scanning circuit 2 controls the control signal RES from the low level to the high level for the pixels 11 in the row (Nth row) to be read. The reset transistor M3 is turned on, and the input node FD is reset to a voltage corresponding to the voltage VDD. As a result, the pixel signal (reset signal) of the reset level is output from each pixel 11 in the Nth row. Although not illustrated in FIG. 3, before time t1, the vertical scanning circuit 2 controls the control signal SEL from the low level to the high level for the pixels 11 in the row (Nth row) to be read. The selection transistor M5 is turned on, and each pixel 11 in the Nth row is connected to the column signal line 13. Before time t1, an operation of transferring a reset signal N_AF of the (N−1)th row from the memory 52 to the signal processing circuit 7 is started.

At time t2, the horizontal scanning circuit 6 ends the operation of transferring the reset signal N_AF of the (N−1)th row from the memory 52 to the signal processing circuit 7.

From time t3 to time t4, the column signal processing circuit 5 performs AD conversion on the reset signal N_AF output from each pixel 11 in the Nth row and stores the reset signal N_AF after AD conversion in the memory 52.

At time t5, the horizontal scanning circuit 6 starts an operation of transferring a focus detection pixel signal S1 of the (N−1)th row from the memory 52 to the signal processing circuit 7.

At time t6, the vertical scanning circuit 2 controls a control signal TX_1 from the low level to the high level for the pixels 11 in the Nth row. The transfer transistor M1 is turned on, and the signal charge held in the photoelectric conversion element PD1 is transferred to the input node FD. As a result, the focus detection pixel signal S1 is output from each pixel 11 in the Nth row.

At time t7, the horizontal scanning circuit 6 ends the operation of transferring the focus detection pixel signal S1 of the (N−1)th row.

From time t8 to time t9, the column signal processing circuit 5 performs AD conversion on the focus detection pixel signal S1 output from each pixel 11 in the Nth row and stores the focus detection pixel signal S1 after AD conversion in the memory 52.

At time t10, the horizontal scanning circuit 6 starts an operation of transferring an imaging pixel signal S2 of the (N−1)th row from the memory 52 to the signal processing circuit 7.

At time t11, the vertical scanning circuit 2 controls the control signals TX_1 and TX_2 from the low level to the high level for the pixels 11 in the Nth row. The transfer transistors M1 and M2 are turned on, and the signal charges held in the photoelectric conversion elements PD1 and PD2 are transferred to the input node FD. As a result, an imaging pixel signal S2 is output from each pixel 11 in the Nth row.

At time t12, the horizontal scanning circuit 6 ends the operation of transferring the imaging pixel signal S2 of the (N−1)th row.

From time t13 to time t14, the column signal processing circuit 5 performs AD conversion on the imaging pixel signal S2 output from each pixel 11 in the Nth row and stores the imaging pixel signal S2 after AD conversion in the memory 52.

At time t15, the vertical scanning circuit 2 controls the control signal RES from the low level to the high level for the pixels 11 in the (N+1)th row to be read next. As a result, the reset signal N_AF is output from each pixel 11 in the (N+1)th row.

At time t15, the horizontal scanning circuit 6 starts an operation of transferring the reset signal N_AF of the Nth row from the memory 52 to the signal processing circuit 7.

At time t16, the horizontal scanning circuit 6 ends the operation of transferring the reset signal N_AF of the Nth row. As described above, the horizontal scanning circuit 6 transfers the reset signal N_AF of the Nth row at the time t15 to t16.

From time t17 to time t18, the column signal processing circuit 5 performs AD conversion on the reset signal N_AF output from each pixel 11 in the (N+1)th row and stores the reset signal N_AF after AD conversion in the memory 52.

At time t19, the horizontal scanning circuit 6 starts an operation of transferring the focus detection pixel signal S1 of the Nth row from the memory 52 to the signal processing circuit 7.

At time t20, the vertical scanning circuit 2 controls the control signal TX_1 from the low level to the high level for the pixels 11 in the (N+1)th row. As a result, the focus detection pixel signal S1 is output from each pixel 11 in the (N+1)th row.

At time t21, the horizontal scanning circuit 6 ends the operation of transferring the focus detection pixel signal S1 of the Nth row. As described above, the horizontal scanning circuit 6 transfers the focus detection pixel signal S1 of the Nth row from the time t19 to the time t21.

At times t22 to t23, the column signal processing circuit 5 performs AD conversion on the focus detection pixel signal S1 output from each pixel 11 in the (N+1)th row and stores the focus detection pixel signal S1 after AD conversion in the memory 52.

At time t24, the horizontal scanning circuit 6 starts an operation of transferring the imaging pixel signal S2 of the Nth row from the memory 52 to the signal processing circuit 7.

At time t25, the vertical scanning circuit 2 controls the control signals TX_1 and TX_2 from the low level to the high level for the pixels 11 in the (N+1)th row. As a result, the imaging pixel signal S2 is output from each pixel 11 in the (N+1)th row.

At time t26, the horizontal scanning circuit 6 ends the operation of transferring the imaging pixel signal S2 of the Nth row. As described above, the horizontal scanning circuit 6 transfers the imaging pixel signal S2 of the Nth row from the time t24 to the time t26.

From time t27 to time t28, the column signal processing circuit 5 performs AD conversion on the imaging pixel signal S2 output from each pixel 11 in the (N+1)th row and stores the imaging pixel signal S2 after AD conversion in the memory 52.

At time t29, the vertical scanning circuit 2 controls the control signal RES from the low level to the high level for the pixels 11 in the (N+2)th row to be read next. As a result, the reset signal N_AF is output from each pixel 11 in the (N+2)th row.

The period from time t15 to time t29 is a period in which the signals output from each pixel 11 in the Nth row is transferred from the memory 52 to the signal processing circuit 7. In the period from time t15 to time t29, as described above, the horizontal scanning circuit 6 transfers the reset signal N_AF of the Nth row in the transfer period (time t15 to time t16). The transfer period (time t15 to time t16) is a period different from the AD conversion period and is positioned between the AD conversion period (time t13 to time t14) of the Nth row and the AD conversion period (time t17 to time t18) of the (N+1)th row.

Further, the horizontal scanning circuit 6 transfers the focus detection pixel signal S1 of the Nth row in the transfer period (time t19 to t21). The transfer period (time t19 to t21) is a period different from the AD conversion period and is positioned between the AD conversion period (time t17 to t18) of the (N+1)th row and the AD conversion period (time t22 to t23) of the (N+1)th row.

In addition, the horizontal scanning circuit 6 transfers the imaging pixel signal S2 of the Nth row in the transfer period (time t24 to t26). The transfer period (time t24 to t26) is a period different from the AD conversion period and is positioned between the AD conversion period (time t22 to t23) of the (N+1)th row and the AD conversion period (time t27 to t28) of the (N+1)th row.

In this way, the horizontal scanning circuit 6 transfers the signals (reset signal N_AF, focus detection pixel signal S1, and imaging pixel signal S2) output from each pixel 11 in the Nth row from the memory 52 to the signal processing circuit 7 in a transfer period different from the AD conversion period. Before performing AD conversion on each signal, a signal transfer operation, which is a series of transfer operations for sequentially outputting signals from each memory 52, is performed one time at a time. That is, the number of signal transfer operations is the same between the AD conversion period and the AD conversion period. Here, noise may occur at the time of AD conversion due to power supply fluctuation at the time of performing the signal transfer operation. In such a case, since the number of signal transfer operations between the AD conversion periods can be made equal, the influence of noise on each signal can be made equal. Accordingly, the noise of the focus detection pixel signal S1 and the imaging pixel signal S2 can be accurately removed by using the reset signal N_AF. Therefore, it is possible to obtain a signal in which the influence of noise due to power supply fluctuation is effectively reduced by a S-N operation of removing noise.

### Second Comparative Example

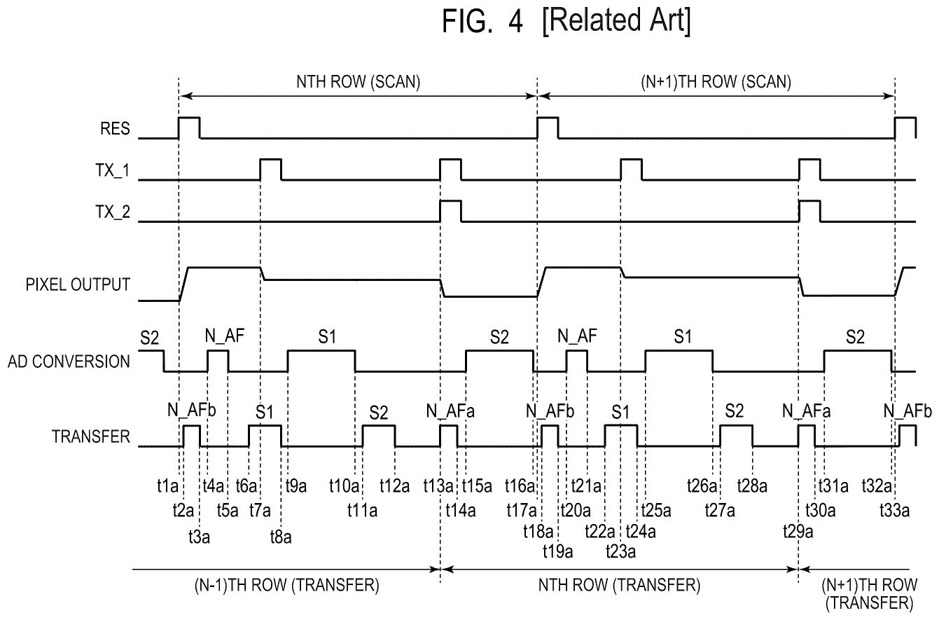

FIG. 4 is a timing chart of an imaging device according to a second comparative example. In FIG. 4, an example in which scanning is performed in the AF imaging mode in the Nth row and the (N+1)th row will be described. In this example, the reset signal N_AF is divided into two parts (reset signals N_AFa and N_AFb) for transmission. The same contents as those described with reference to FIG. 3 are omitted or simplified as appropriate.

At time t1a, the vertical scanning circuit 2 controls the control signal RES from the low level to the high level for the pixels 11 in the row (Nth row) to be read. The reset transistor M3 is turned on, and the input node FD is reset to a voltage corresponding to the voltage VDD. As a result, the reset signal is output from each pixel 11 in the Nth row.

At time t2a, the horizontal scanning circuit 6 starts an operation of transferring a reset signal N_AFb of the (N−1)th row from the memory 52 to the signal processing circuit 7.

At time t3a, the horizontal scanning circuit 6 ends the operation of transferring the reset signal N_AFb of the (N−1)th row.

From time t4a to time t5a, the column signal processing circuit 5 performs AD conversion on the reset signal N_AF output from each pixel 11 in the Nth row and stores the reset signal N_AF after AD conversion in the memory 52.

At time toa, the horizontal scanning circuit 6 starts an operation of transferring the focus detection pixel signal S1 of the (N−1)th row from the memory 52 to the signal processing circuit 7.

At time t7a, the vertical scanning circuit 2 controls the control signal TX_1 from the low level to the high level for the pixels 11 in the Nth row. The transfer transistor M1 is turned on, and the signal charge held in the photoelectric conversion element PD1 is transferred to the input node FD. As a result, the focus detection pixel signal S1 is output from each pixel 11 in the Nth row.

At time t8a, the horizontal scanning circuit 6 ends the operation of transferring the focus detection pixel signal S1 of the (N−1)th row.

At times t9a to t10a, the column signal processing circuit 5 performs AD conversion on the focus detection pixel signal S1 output from each pixel 11 in the Nth row and stores the focus detection pixel signal S1 after AD conversion in the memory 52.

At time t11a, the horizontal scanning circuit 6 starts an operation of transferring the imaging pixel signal S2 of the (N−1)th row from the memory 52 to the signal processing circuit 7.

At time t12a, the horizontal scanning circuit 6 ends the operation of transferring the imaging pixel signal S2 of the (N−1)th row.

At time t13a, the vertical scanning circuit 2 controls the control signals TX_1 and TX_2 from the low level to the high level for the pixels 11 in the Nth row. The transfer transistors M1 and M2 are turned on, and the signal charges held in the photoelectric conversion elements PD1 and PD2 are transferred to the input node FD. As a result, the imaging pixel signal S2 is output from each pixel 11 in the Nth row.

At time t13a, the horizontal scanning circuit 6 starts an operation of transferring a reset signal N_AFa of the Nth row from the memory 52 to the signal processing circuit 7.

At time t14a, the horizontal scanning circuit 6 ends the operation of transferring the reset signal N_AFa of the Nth row. As described above, the horizontal scanning circuit 6 transfers the reset signal N_AFa of the Nth row at the time t13a to t14a.

From time t15a to time t16a, the column signal processing circuit 5 performs AD conversion on the imaging pixel signal S2 output from each pixel 11 in the Nth row and stores the imaging pixel signal S2 after AD conversion in the memory 52.

At time t17a, the vertical scanning circuit 2 controls the control signal RES from the low level to the high level for the pixels 11 in the (N+1)th row to be read next. As a result, the reset signal N_AF is output from each pixel 11 in the (N+1)th row.

At time t18a, the horizontal scanning circuit 6 starts an operation of transferring the reset signal N_AFb of the Nth row from the memory 52 to the signal processing circuit 7.

At time t19a, the horizontal scanning circuit 6 ends the operation of transferring the reset signal N_AFb of the Nth row. As described above, the horizontal scanning circuit 6 transfers the reset signal N_AFb of the Nth row at the time t18a to t19a.

From time t20a to time t21a, the column signal processing circuit 5 performs AD conversion on the reset signal N_AF output from each pixel 11 in the (N+1)th row and stores the reset signal N_AF after AD conversion in the memory 52.

At time t22a, the horizontal scanning circuit 6 starts an operation of transferring the focus detection pixel signal S1 of the Nth row from the memory 52 to the signal processing circuit 7.

At time t23a, the vertical scanning circuit 2 controls the control signal TX_1 from the low level to the high level for the pixels 11 in the (N+1)th row. As a result, the focus detection pixel signal S1 is output from each pixel 11 in the (N+1)th row.

At time t24a, the horizontal scanning circuit 6 ends the operation of transferring the focus detection pixel signal S1 of the Nth row. As described above, the horizontal scanning circuit 6 transfers the focus detection pixel signal S1 of the Nth row from the time t22a to the time t24a.

From time t25a to time t26a, the column signal processing circuit 5 performs AD conversion on the focus detection pixel signal S1 output from each pixel 11 in the (N+1)th row and stores the focus detection pixel signal S1 after AD conversion in the memory 52.

At time t27a, the horizontal scanning circuit 6 starts an operation of transferring the imaging pixel signal S2 of the Nth row from the memory 52 to the signal processing circuit 7.

At time t28a, the horizontal scanning circuit 6 ends the operation of transferring the imaging pixel signal S2 of the Nth row. As described above, the horizontal scanning circuit 6 transfers the imaging pixel signal S2 of the Nth row from the time t27a to the time t28a.

At time t29a, the vertical scanning circuit 2 controls the control signals TX_1 and TX_2 from the low level to the high level for the pixels 11 in the (N+1)th row. The transfer transistors M1 and M2 are turned on, and the signal charges held in the photoelectric conversion elements PD1 and PD2 are transferred to the input node FD. As a result, the imaging pixel signal S2 is output from each pixel 11 in the (N+1)th row.

At time t29a, the horizontal scanning circuit 6 starts an operation of transferring the reset signal N_AFa of the (N+1)th row from the memory 52 to the signal processing circuit 7.

At time t30a, the horizontal scanning circuit 6 ends the operation of transferring the reset signal N_AFa of the (N+1)th row.

From time t31a to time t32a, the column signal processing circuit 5 performs AD conversion on the imaging pixel signal S2 output from each pixel 11 in the (N+1)th row and stores the imaging pixel signal S2 after AD conversion in the memory 52.

At time t33a, the vertical scanning circuit 2 controls the control signal RES from the low level to the high level for the pixels 11 in the (N+2)th row to be read next. As a result, the reset signal N_AF is output from each pixel 11 in the (N+2)th row.

The period from the time t13a to the time t29a is a period in which the signals output from each pixel 11 in the Nth row is transferred from the memory 52 to the signal processing circuit 7. In the period from time t13a to time t29a, as described above, the horizontal scanning circuit 6 transfers the reset signal N_AFa of the Nth row in the transfer period (time t13a to time t14a). The transfer period (time t13a to time t14a) is a period different from the AD conversion period and is positioned between the AD conversion period of the Nth row (time t9a to time t10a) and the AD conversion period of the Nth row (time t15a to time t16a).

In addition, the horizontal scanning circuit 6 transfers the reset signal N_AFb of the Nth row in the transfer period (time t18a to t19a). The transfer period (time t18a to t19a) is a period different from the AD conversion period and is positioned between the AD conversion period of the Nth row (time t15a to t16a) and the AD conversion period of the (N+1)th row (time t20a to t21a).

Further, the horizontal scanning circuit 6 transfers the focus detection pixel signal S1 of the Nth row in the transfer period (time t22a to t24a). The transfer period (time t22a to t24a) is a period different from the AD conversion period and is positioned between the AD conversion period (time t20a to t21a) of the (N+1)th row and the AD conversion period (time t25a to t26a) of the (N+1)th row.

In addition, the horizontal scanning circuit 6 transfers the imaging pixel signal S2 of the Nth row in the transfer period (time t27a to t28a). The transfer period (time t27a to t28a) is a period different from the AD conversion period and is positioned between the AD conversion period (time t25a to t26a) of the (N+1)th row and the AD conversion period (time t31a to t32a) of the (N+1)th row.

As described above, the horizontal scanning circuit 6 transfers the signals (two divided reset signals N_AFa and N_AFb, the focus detection pixel signal S1, and the imaging pixel signal S2) output from each pixel 11 in the Nth row from the memory 52 to the signal processing circuit 7 in the transfer period different from the AD conversion period. Before AD conversion of each signal, a signal transfer operation is performed at least once. Therefore, the noise due to the power supply fluctuation at the time of performing the signal transfer operation similarly affects each AD conversion process. Accordingly, the noise of the focus detection pixel signal S1 and the imaging pixel signal S2 can be accurately removed by using the reset signal N_AF.

### Third Comparative Example

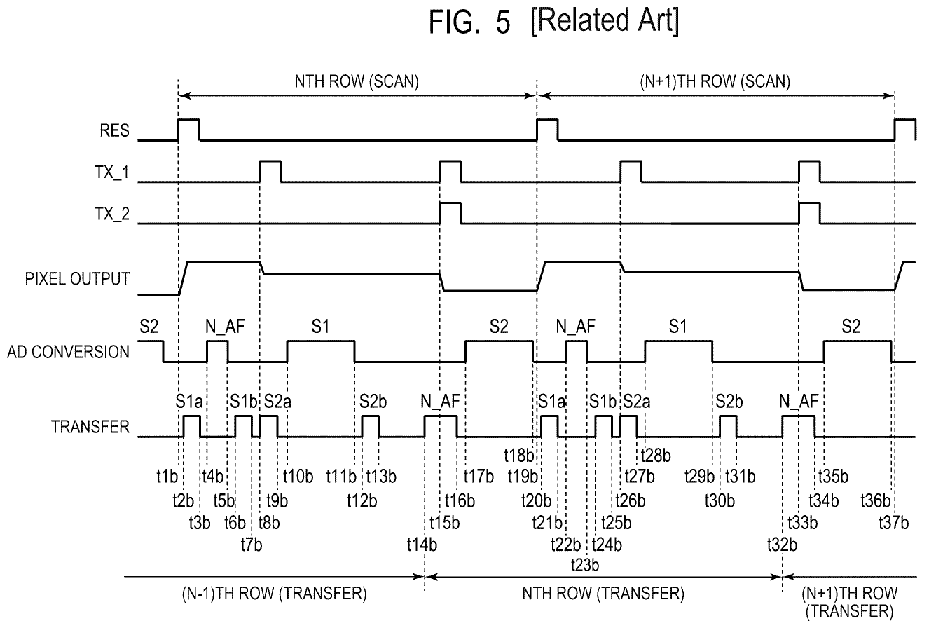

FIG. 5 is a timing chart of an imaging device according to a third comparative example. In FIG. 5, an example in which scanning is performed in the AF imaging mode in the Nth row and the (N+1)th row will be described. In this example, the focus detection pixel signal S1 and the imaging pixel signal S2 are respectively divided into two parts (focus detection pixel signals S1a and S1b, imaging pixel signals S2a and S2b) for transmission. The same contents as those described with reference to FIG. 3 are omitted or simplified as appropriate.

At time t1b, the vertical scanning circuit 2 controls the control signal RES from the low level to the high level for the pixels 11 in the row (Nth row) to be read. The reset transistor M3 is turned on, and the input node FD is reset to a voltage corresponding to the voltage VDD. As a result, the reset signal is output from each pixel 11 in the Nth row.

At time t2b, the horizontal scanning circuit 6 starts an operation of transferring a focus detection pixel signal S1a of the (N−1)th row from the memory 52 to the signal processing circuit 7.

At time t3b, the horizontal scanning circuit 6 ends the operation of transferring the focus detection pixel signal S1a of the (N−1)th row.

From time t4b to time t5b, the column signal processing circuit 5 performs AD conversion on the reset signal N_AF output from each pixel 11 in the Nth row and stores the reset signal N_AF after AD conversion in the memory 52.

At time t6b, the horizontal scanning circuit 6 starts an operation of transferring a focus detection pixel signal S1b of the (N−1)th row from the memory 52 to the signal processing circuit 7.

At time t7b, the horizontal scanning circuit 6 ends the operation of transferring the focus detection pixel signal S1b of the (N−1)th row.

At time t8b, the vertical scanning circuit 2 controls the control signal TX_1 from the low level to the high level for the pixels 11 in the Nth row. The transfer transistor M1 is turned on, and the signal charge held in the photoelectric conversion element PD1 is transferred to the input node FD. As a result, the focus detection pixel signal S1 is output from each pixel 11 in the Nth row.

At time t8b, the horizontal scanning circuit 6 starts an operation of transferring an imaging pixel signal S2a of the (N−1)th row from the memory 52 to the signal processing circuit 7.

At time t9b, the horizontal scanning circuit 6 ends the operation of transferring the imaging pixel signal S2a of the (N−1)th row.

From time t10b to time t11b, the column signal processing circuit 5 performs AD conversion on the focus detection pixel signal S1 output from each pixel 11 in the Nth row and stores the focus detection pixel signal S1 after AD conversion in the memory 52.

At time t12b, the horizontal scanning circuit 6 starts an operation of transferring an imaging pixel signal S2b of the (N−1)th row from the memory 52 to the signal processing circuit 7.

At time t13b, the horizontal scanning circuit 6 ends the operation of transferring the imaging pixel signal S2b of the (N−1)th row.

At time t14b, the horizontal scanning circuit 6 starts an operation of transferring the reset signal N_AF of the Nth row from the memory 52 to the signal processing circuit 7.

At time t15b, the vertical scanning circuit 2 controls the control signals TX_1 and TX_2 from the low level to the high level for the pixels 11 in the Nth row. The transfer transistors M1 and M2 are turned on, and the signal charges held in the photoelectric conversion elements PD1 and PD2 are transferred to the input node FD. As a result, the imaging pixel signal S2 is output from each pixel 11 in the Nth row.

At time t16b, the horizontal scanning circuit 6 ends the operation of transferring the reset signal N_AF of the Nth row. As described above, the horizontal scanning circuit 6 transfers the reset signal N_AF of the Nth row from the time t14b to the time t16b.

From time t17b to time t18b, the column signal processing circuit 5 performs AD conversion on the imaging pixel signal S2 output from each pixel 11 in the Nth row and stores the imaging pixel signal S2 after AD conversion in the memory 52.

At time t19b, the vertical scanning circuit 2 controls the control signal RES from the low level to the high level for the pixels 11 in the (N+1)th row to be read next. As a result, the reset signal N_AF is output from each pixel 11 in the (N+1)th row.

At time t20b, the horizontal scanning circuit 6 starts an operation of transferring the focus detection pixel signal S1a of the Nth row from the memory 52 to the signal processing circuit 7.

At time t21b, the horizontal scanning circuit 6 ends the operation of transferring the focus detection pixel signal S1a of the Nth row. As described above, the horizontal scanning circuit 6 transfers the focus detection pixel signal S1a of the Nth row from the time t20b to the time t21b.

From time t22b to time t23b, the column signal processing circuit 5 performs AD conversion on the reset signal N_AF output from each pixel 11 in the Nth row and stores the reset signal N_AF after AD conversion in the memory 52.

At time t24b, the horizontal scanning circuit 6 starts an operation of transferring the focus detection pixel signal S1b of the Nth row from the memory 52 to the signal processing circuit 7.

At time t25b, the horizontal scanning circuit 6 ends the operation of transferring the focus detection pixel signal S1b of the Nth row. As described above, the horizontal scanning circuit 6 transfers the focus detection pixel signal S1b of the Nth row from the time t24b to the time t25b.

At time t26b, the vertical scanning circuit 2 controls the control signal TX_1 from the low level to the high level for the pixels 11 in the Nth row. The transfer transistor M1 is turned on, and the signal charge held in the photoelectric conversion element PD1 is transferred to the input node FD. As a result, the focus detection pixel signal S1 is output from each pixel 11 in the Nth row.

At time t26b, the horizontal scanning circuit 6 starts an operation of transferring the imaging pixel signal S2a of the Nth row from the memory 52 to the signal processing circuit 7.

At time t27b, the horizontal scanning circuit 6 ends the operation of transferring the imaging pixel signal S2a of the Nth row. As described above, the horizontal scanning circuit 6 transfers the imaging pixel signal S2a of the Nth row from the time t26b to the time t27b.

From time t28b to time t29b, the column signal processing circuit 5 performs AD conversion on the focus detection pixel signal S1 output from each pixel 11 in the (N+1)th row and stores the focus detection pixel signal S1 after AD conversion in the memory 52.

At time t30b, the horizontal scanning circuit 6 starts an operation of transferring the imaging pixel signal S2b of the Nth row from the memory 52 to the signal processing circuit 7.

At time t31b, the horizontal scanning circuit 6 ends the operation of transferring the imaging pixel signal S2b of the Nth row. As described above, the horizontal scanning circuit 6 transfers the imaging pixel signal S2b of the Nth row from the time t30b to the time t31b.

At time t32b, the horizontal scanning circuit 6 starts an operation of transferring the reset signal N_AF of the (N+1)th row from the memory 52 to the signal processing circuit 7.

At time t33b, the vertical scanning circuit 2 controls the control signals TX_1 and TX_2 from the low level to the high level for the pixels 11 in the (N+1)th row. The transfer transistors M1 and M2 are turned on, and the signal charges held in the photoelectric conversion elements PD1 and PD2 are transferred to the input node FD. As a result, the imaging pixel signal S2 is output from each pixel 11 in the Nth row.

At time t34b, the horizontal scanning circuit 6 ends the operation of transferring the reset signal N_AF of the (N+1)th row. As described above, the horizontal scanning circuit 6 transfers the reset signal N_AF of the (N+1)th row from the time t32b to the time t34b.

From time t35b to time t36b, the column signal processing circuit 5 performs AD conversion on the imaging pixel signal S2 output from each pixel 11 in the (N+1)th row and stores the imaging pixel signal S2 after AD conversion in the memory 52.

At time t37b, the vertical scanning circuit 2 controls the control signal RES from the low level to the high level for the pixels 11 in the (N+2)th row to be read next. As a result, the reset signal N_AF is output from each pixel 11 in the (N+2)th row.

The period from the time t14b to the time t32b is a period in which the signals output from each pixel 11 in the Nth row is transferred from the memory 52 to the signal processing circuit 7. In the period of time t14b to t32b, the horizontal scanning circuit 6 transfers the reset signal N_AF of the Nth row in the transfer period (t14b to t16b) as described above. The transfer period (t14b to t16b) is a period different from the AD conversion period and is positioned between the AD conversion period of the Nth row (time t10b to t11b) and the AD conversion period of the Nth row (time t17b to t18b).

Further, the horizontal scanning circuit 6 transfers the focus detection pixel signal S1a of the Nth row in the transfer period (t20b to t21b). The transfer period (t20b to t21b) is a period different from the AD conversion period and is positioned between the AD conversion period (time t17b to t18b) of the Nth row and the AD conversion period (time t22b to t23b) of the (N+1)th row.

Further, the horizontal scanning circuit 6 transfers the focus detection pixel signal S1b of the Nth row in the transfer period (t24b to t25b). The transfer period (t24b to t25b) is a period different from the AD conversion period and is positioned between the AD conversion period (time t22b to t23b) of the (N+1)th row and the AD conversion period (time t28b to t29b) of the (N+1)th row.

In addition, the horizontal scanning circuit 6 transfers the imaging pixel signal S2a of the Nth row in the transfer period (t26b to t27b). The transfer period (t26b to t27b) is a period different from the AD conversion period and is positioned between the AD conversion period (time t22b to t23b) of the (N+1)th row and the AD conversion period (time t28b to t29b) of the (N+1)th row.

In addition, the horizontal scanning circuit 6 transfers the imaging pixel signal S2b of the Nth row in the transfer period (t30b to t31b). The transfer period (t30b to t31b) is a period different from the AD conversion period and is positioned between the AD conversion period (time t28b to t29b) of the (N+1)th row and the AD conversion period (time t35b to t36b) of the (N+1)th row.

As described above, the horizontal scanning circuit 6 transfers the signals (reset signal N_AF, two-divided focus detection pixel signals S1a and S1b, and two-divided imaging pixel signals S2a and S2b) output from each pixel 11 in the Nth row in the transfer period different from the AD conversion period. Before AD conversion of each signal, a signal transfer operation is performed at least once. Therefore, the noise due to the power supply fluctuation at the time of performing the signal transfer operation similarly affects each AD conversion process. Accordingly, the noise of the focus detection pixel signal S1 and the imaging pixel signal S2 can be accurately removed by using the reset signal N_AF.

### Fourth Comparative Example

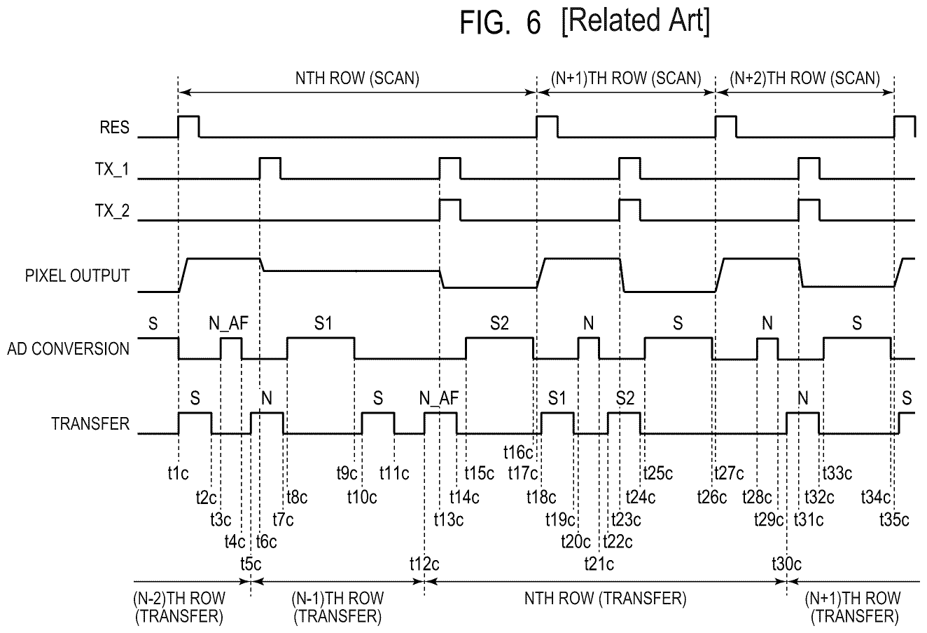

FIG. 6 is a timing chart of an imaging device according to a fourth comparative example. In FIG. 6, an example in which scanning is performed in the AF imaging mode in the Nth row and is performed in the imaging mode in the (N+1)th row and the (N+2)th row will be described. That is, an example of transition from the AF imaging mode to the imaging mode will be described. The same contents as those described with reference to FIG. 3 are omitted or simplified as appropriate.

At time t1c, the vertical scanning circuit 2 scans the pixels 11 in the AF imaging mode. The vertical scanning circuit 2 controls the control signal RES from the low level to the high level for the pixels 11 in the row (Nth row) to be read. The reset transistor M3 is turned on, and the input node FD is reset to a voltage corresponding to the voltage VDD. As a result, the reset signal N_AF is output from each pixel 11 in the Nth row.

At time t1c, the horizontal scanning circuit 6 starts an operation of transferring the imaging pixel signal S of the (N−2)th row from the memory 52 to the signal processing circuit 7.

At time t2c, the horizontal scanning circuit 6 ends the operation of transferring the imaging pixel signal S of the (N−2)th row.

From time t3c to time t4c, the column signal processing circuit 5 performs AD conversion on the reset signal N_AF output from each pixel 11 in the Nth row and stores the reset signal N_AF after AD conversion in the memory 52.

At time t5c, the horizontal scanning circuit 6 starts an operation of transferring the reset signal N of the (N−1)th row from the memory 52 to the signal processing circuit 7.

At time toc, the vertical scanning circuit 2 controls the control signal TX_1 from the low level to the high level for the pixels 11 in the Nth row. The transfer transistor M1 is turned on, and the signal charge held in the photoelectric conversion element PD1 is transferred to the input node FD. As a result, the focus detection pixel signal S1 is output from each pixel 11 in the Nth row.

At time t7c, the horizontal scanning circuit 6 ends the operation of transferring the reset signal N of the (N−1)th row.

From time t8c to time t9c, the column signal processing circuit 5 performs AD conversion on the focus detection pixel signal S1 output from each pixel 11 in the Nth row and stores the focus detection pixel signal S1 after AD conversion in the memory 52.

At time t10c, the horizontal scanning circuit 6 starts an operation of transferring the imaging pixel signal S of the (N−1)th row from the memory 52 to the signal processing circuit 7.

At time t11c, the horizontal scanning circuit 6 ends the operation of transferring the imaging pixel signal S of the (N−1)th row.

At time t12c, the horizontal scanning circuit 6 starts an operation of transferring the reset signal N_AF of the Nth row from the memory 52 to the signal processing circuit 7.

At time t13c, the vertical scanning circuit 2 controls the control signals TX_1 and TX_2 from the low level to the high level for the pixels 11 in the Nth row. The transfer transistors M1 and M2 are turned on, and the signal charges held in the photoelectric conversion elements PD1 and PD2 are transferred to the input node FD. As a result, the imaging pixel signal S2 is output from each pixel 11 in the Nth row.

At time t14c, the horizontal scanning circuit 6 ends the operation of transferring the reset signal N_AF of the Nth row. As described above, the horizontal scanning circuit 6 transfers the reset signal N_AF of the Nth row from the time t12c to the time t14c.

From time t15c to time t16c, the column signal processing circuit 5 performs AD conversion on the imaging pixel signal S2 output from each pixel 11 in the Nth row and stores the imaging pixel signal S2 after AD conversion in the memory 52.

At time t17c, the vertical scanning circuit 2 transitions from the AF imaging mode to the imaging mode. The vertical scanning circuit 2 controls the control signal RES from the low level to the high level for the pixels 11 in the (N+1)th row to be read next. As a result, the reset signal N is output from each pixel 11 in the (N+1)th row.

At time t18c, the horizontal scanning circuit 6 starts an operation of transferring the focus detection pixel signal S1 of the Nth row from the memory 52 to the signal processing circuit 7.

At time t19c, the horizontal scanning circuit 6 ends the operation of transferring the focus detection pixel signal S1 of the Nth row. As described above, the horizontal scanning circuit 6 transfers the focus detection pixel signal S1 of the Nth row from the time t18c to the time t19c.

From time t20c to time t21c, the column signal processing circuit 5 performs AD conversion on the reset signal N output from each pixel 11 in the (N+1)th row and stores the reset signal N after AD conversion in the memory 52.

At time t22c, the horizontal scanning circuit 6 starts an operation of transferring the imaging pixel signal S2 of the Nth row from the memory 52 to the signal processing circuit 7.

At time t23c, the vertical scanning circuit 2 controls the control signals TX_1 and TX_2 from the low level to the high level for the pixels 11 in the (N+1)th row. As a result, the imaging pixel signal S is output from each pixel 11 in the (N+1)th row.

At time t24c, the horizontal scanning circuit 6 ends the operation of transferring the imaging pixel signal S2 of the Nth row. As described above, the horizontal scanning circuit 6 transfers the imaging pixel signal S2 of the Nth row from the time t22c to the time t24c.

From time t25c to time t26c, the column signal processing circuit 5 performs AD conversion on the imaging pixel signal S output from each pixel 11 in the (N+1)th row and stores the imaging pixel signal S after AD conversion in the memory 52.

At time t27c, the vertical scanning circuit 2 controls the control signal RES from the low level to the high level for the pixels 11 in the (N+2)th row to be read next. As a result, the reset signal N is output from each pixel 11 in the (N+2)th row.

From time t28c to time t29c, the column signal processing circuit 5 performs AD conversion on the reset signal N output from each pixel 11 in the (N+2)th row and stores the reset signal N after AD conversion in the memory 52.

At time t30c, the horizontal scanning circuit 6 starts an operation of transferring the reset signal N of the (N+1)th row from the memory 52 to the signal processing circuit 7.

At time t31c, the vertical scanning circuit 2 controls the control signals TX_1 and TX_2 from the low level to the high level for the pixels 11 in the (N+2)th row. As a result, the imaging pixel signal S is output from each pixel 11 in the (N+2)th row.

At time t32c, the horizontal scanning circuit 6 ends the operation of transferring the reset signal N of the (N+2)th row. As described above, the horizontal scanning circuit 6 transfers the reset signal N of the (N+1)th row from the time t30c to the time t32c.

From time t33c to time t34c, the column signal processing circuit 5 performs AD conversion on the imaging pixel signal S output from each pixel 11 in the (N+2)th row and stores the imaging pixel signal S after AD conversion in the memory 52.

At time t35c, the vertical scanning circuit 2 controls the control signal RES from the low level to the high level for the pixels 11 in the (N+3)th row to be read next. As a result, the reset signal N is output from each pixel 11 in the (N+3)th row.

The period from the time t12c to the time t30c is a period in which the signals output from each pixel 11 in the Nth row is transferred from the memory 52 to the signal processing circuit 7. In the period from time t12c to time t30c, as described above, the horizontal scanning circuit 6 transfers the reset signal N_AF of the Nth row in the transfer period (time t12c to time t14c). The transfer period (time t12c to t14c) is a period different from the AD conversion period and is positioned between the AD conversion period (time t8 to t9) of the Nth row and the AD conversion period (time t15c to t16c) of the Nth row.

Further, the horizontal scanning circuit 6 transfers the focus detection pixel signal S1 of the Nth row in the transfer period (time t18c to t19c). The transfer period (time t18c to t19c) is a period different from the AD conversion period and is positioned between the AD conversion period of the Nth row (time t15c to t16c) and the AD conversion period of the (N+1)th row (time t20 to t21).

In addition, the horizontal scanning circuit 6 transfers the imaging pixel signal S2 of the Nth row in the transfer period (time t22c to t24c). The transfer period (time t22c to t24c) is a period different from the AD conversion period and is positioned between the AD conversion period (time t20c to t21c) of the (N+1)th row and the AD conversion period (time t25c to t26c) of the (N+1)th row.

The horizontal scanning circuit 6 transfers the reset signal N of the (N+1)th row in the transfer period (time t30c to t32c). The transfer period (time t30c to t32c) is a period different from the AD conversion period and is positioned between the AD conversion period (time t28c to t29c) of the (N+2)th row and the AD conversion period (time t33c to t34c) of the (N+2)th row.

Incidentally, in the case of transition from the AF imaging mode to the imaging mode, the signal transfer operation is not performed between the AD conversion period of the (N+1)th row (time t25c to t26c) and the AD conversion period of the (N+2)th row (time t28c to t29c). This is because the number of signals (three) used for scanning in the AF imaging mode is different from the number of signals (two) used for scanning in the imaging mode, and therefore, when the imaging mode is changed from the AF imaging mode, the signal transfer operation is not performed between specific AD conversion periods. In this case, there is a case where the influence of noise due to power supply fluctuation at the time of performing the signal transfer operation differs depending on the AD conversion processing.

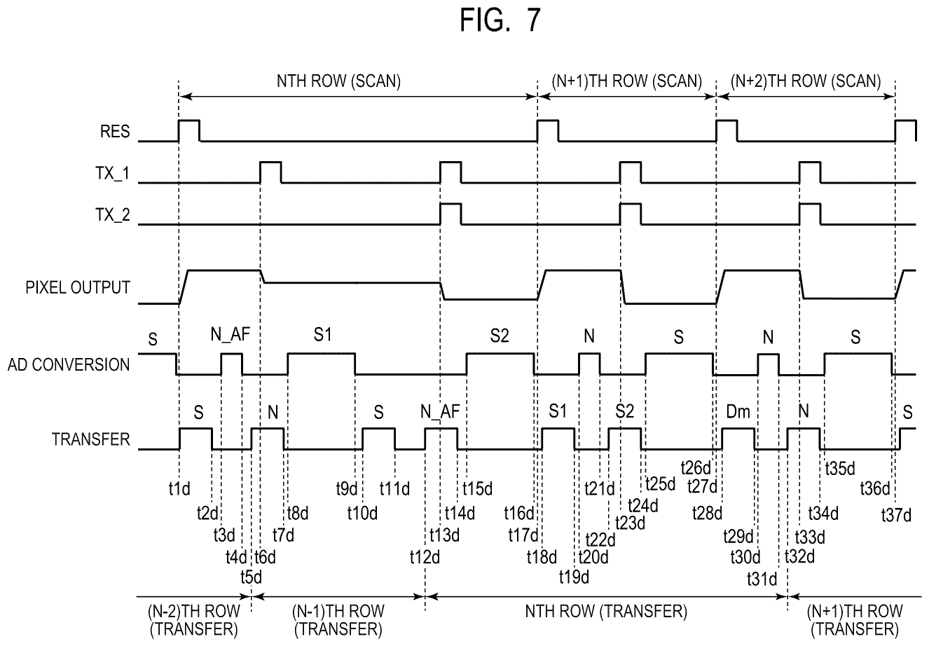

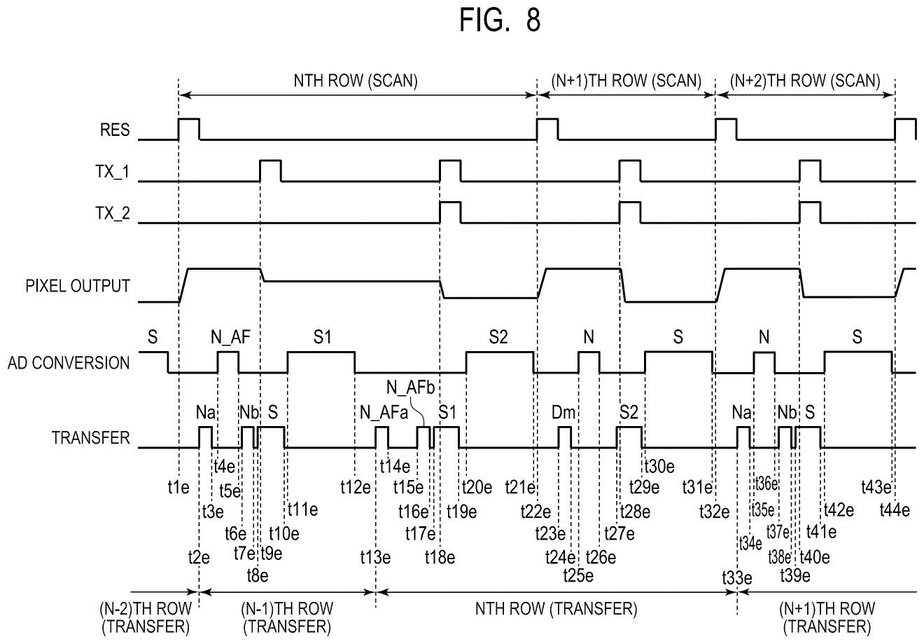

Here, the signal transfer operation is not performed between the AD conversion period of the (N+1)th row (time t25c to t26c) and the AD conversion period of the (N+2)th row (time t28c to t29c). Therefore, the AD conversion processing performed in the AD conversion period (time t28c to t29c) of the (N+2)th row is unlikely to be affected by noise due to the power supply fluctuation when the signal transfer operation is performed. For this reason, in the imaging device according to the present comparative example, when the noise of the imaging pixel signal S is removed using the reset signal N that is converted in the AD conversion period (time t28c to t29c) of the (N+2)th row, there is a problem that the noise cannot be removed with high accuracy. A method of solving this problem will be described with reference to FIGS. 7 and 8.

FIG. 7 is a timing chart of the imaging device 100 according to the present embodiment. In FIG. 7, similarly to FIG. 6, an example of transition from the AF imaging mode to the imaging mode will be described. The same contents as those described with reference to FIG. 6 are omitted or simplified as appropriate.

The process from time t1d to time t27d in FIG. 7 is the same as the process from time t1c to time t27c in FIG. 6.

At time t28d, the horizontal scanning circuit 6 starts a dummy transfer operation (additional signal transfer operation) of transferring a dummy signal Dm from the memory 52 to the signal processing circuit 7. The dummy transfer operation is a pseudo signal transfer operation, and is, for example, a series of transfer operations for sequentially outputting dummy signals held in the memory 52. The dummy signal Dm is a signal different from the pixel signal from the pixel 11, and may be, for example, a signal written in the memory 52 by a dummy signal generation unit (not illustrated). The dummy transfer operation may be only an operation of sequentially performing signal transfer in accordance with scanning of the horizontal scanning circuit 6 without reading a signal held in the memory 52.

The reason for performing the dummy transfer operation is that the signal transfer operation for transferring the actual signal to the signal processing circuit 7 is not performed between the specific AD conversion periods due to the transition from the AF imaging mode to the imaging mode, as described with reference to FIG. 6. By performing the dummy transfer operation between the specific AD conversion periods, the signal transfer operation is performed at least once before the AD conversion processing is performed even when the AF imaging mode is shifted to the imaging mode.

At time t29d, the horizontal scanning circuit 6 ends the dummy transfer operation of transferring the dummy signal Dm. As described above, the horizontal scanning circuit 6 transfers the dummy signal Dm from the time t28d to the time t29d.

The process from time t30d to time t37d is the same as the process from time t28c to time t35c in FIG. 6.

As described above, the horizontal scanning circuit 6 transfers the dummy signal Dm in the transfer period (time t28d to t29d). The transfer period (time t28d to t29d) is a period different from the AD conversion period and is positioned between the AD conversion period (time t25d to t26d) of the (N+1)th row and the AD conversion period (time t30d to t31d) of the (N+2)th row.

As described above, by transferring the dummy signal Dm, the number of times of transferring the signal from the pixel 11 scanned in the AF imaging mode is four, and the number of times of transferring the signal from the pixel 11 scanned in the imaging mode is two. In this way, the number of signal transfers of the pixels 11 scanned in the AF imaging mode is an integer multiple of 2 or more of the number of signal transfers of the pixels 11 scanned in the imaging mode.

In the imaging device 100 according to the present embodiment, when a transition is made from the AF imaging mode to the imaging mode, the dummy transfer operation is performed so that the number of times of the first signal transfer operation and the number of times of the second signal transfer operation are the same in the imaging mode. Here, the number of times of the first signal transfer operation is between the AD conversion period (time t30d to t31d) and the AD conversion period (time t25d to t26d) immediately before the AD conversion period (time t30d to t31d). The number of times of the second signal transfer operation is between the AD conversion period (time t30d to t31d) and the AD conversion period (time t35d to t36d) next to the AD conversion period (time t30d to t31d).

Accordingly, in the imaging mode, the imaging device 100 can make the number of times of the signal transfer operation between the AD conversion periods the same. Therefore, the noise due to the power supply fluctuation at the time of performing the signal transfer operation similarly affects each AD conversion process. Accordingly, the noise of the imaging pixel signal S2 can be accurately removed by using the reset signal N_AF.

In the imaging mode, the period from the end of the first signal transfer operation to the start of the AD conversion period (time t30d to t31d) may be the same as the period from the end of the second signal transfer operation to the start of the next AD conversion period (time t35d to t36d). As a result, the influence of noise on each AD conversion process can be made more equal, and noise can be removed more accurately.

### Second Embodiment

FIG. 8 is a timing chart of the imaging device 100 according to the present embodiment. In FIG. 8, similarly to FIG. 6, an example of transition from the AF imaging mode to the imaging mode will be described. In this example, the reset signal N_AF is divided into two parts (reset signals N_AFa and N_AFb) for transmission.

At time t1e, the vertical scanning circuit 2 scans the pixels 11 in the AF imaging mode. The vertical scanning circuit 2 controls the control signal RES from the low level to the high level for the pixels 11 in the row (Nth row) to be read. The reset transistor M3 is turned on, and the input node FD is reset to a voltage corresponding to the voltage VDD. As a result, the reset signal is output from each pixel 11 in the Nth row.

At time t2e, the horizontal scanning circuit 6 starts an operation of transferring the reset signal Na of the (N−1)th row from the memory 52 to the signal processing circuit 7.

At time t3e, the horizontal scanning circuit 6 ends the operation of transferring the reset signal Na of the (N−1)th row.

From time t4e to time t5e, the column signal processing circuit 5 performs AD conversion on the reset signal N_AF output from each pixel 11 in the Nth row and stores the reset signal N_AF after AD conversion in the memory 52.

At time toe, the horizontal scanning circuit 6 starts an operation of transferring the reset signal Nb of the (N−1)th row from the memory 52 to the signal processing circuit 7.

At time t7e, the horizontal scanning circuit 6 ends the operation of transferring the reset signal Nb of the (N−1)th row.

At time t8e, the horizontal scanning circuit 6 starts an operation of transferring the imaging pixel signal S of the (N−1)th row from the memory 52 to the signal processing circuit 7.

At time t9e, the vertical scanning circuit 2 controls the control signal TX_1 from the low level to the high level for the pixels 11 in the Nth row. The transfer transistor M1 is turned on, and the signal charge held in the photoelectric conversion element PD1 is transferred to the input node FD. As a result, the focus detection pixel signal S1 is output from each pixel 11 in the Nth row.

At time t10e, the horizontal scanning circuit 6 ends the operation of transferring the imaging pixel signal S of the (N−1)th row.

From time t11e to time t12e, the column signal processing circuit 5 performs AD conversion on the focus detection pixel signal S1 output from each pixel 11 in the Nth row and stores the focus detection pixel signal S1 after AD conversion in the memory 52.

At time t13e, the horizontal scanning circuit 6 starts an operation of transferring the reset signal N_AFa of the Nth row from the memory 52 to the signal processing circuit 7.

At time t14e, the horizontal scanning circuit 6 ends the operation of transferring the reset signal N_AFa of the Nth row. As described above, the horizontal scanning circuit 6 transfers the reset signal N_AFa of the Nth row at the time t13e to t14e.

At time t15e, the horizontal scanning circuit 6 starts an operation of transferring the reset signal N_AFb of the Nth row from the memory 52 to the signal processing circuit 7.

At time t16e, the horizontal scanning circuit 6 ends the operation of transferring the reset signal N_AFb of the Nth row. As described above, the horizontal scanning circuit 6 transfers the reset signal N_AFb of the Nth row at the time t15e to t16e.

At time t17e, the horizontal scanning circuit 6 starts an operation of transferring the focus detection pixel signal S1 of the Nth row from the memory 52 to the signal processing circuit 7.

At time t18e, the vertical scanning circuit 2 controls the control signals TX_1 and TX_2 from the low level to the high level for the pixels 11 in the Nth row. The transfer transistors M1 and M2 are turned on, and the signal charges held in the photoelectric conversion elements PD1 and PD2 are transferred to the input node FD. As a result, the imaging pixel signal S2 is output from each pixel 11 in the Nth row.

At time t19e, the horizontal scanning circuit 6 ends the operation of transferring the focus detection pixel signal S1 of the Nth row. As described above, the horizontal scanning circuit 6 transfers the focus detection pixel signal S1 of the Nth row from the time t17e to the time t19e.

From time t20e to time t21e, the column signal processing circuit 5 performs AD conversion on the imaging pixel signal S2 output from each pixel 11 in the Nth row and stores the imaging pixel signal S2 after AD conversion in the memory 52.

At time t22e, the vertical scanning circuit 2 transitions from the AF imaging mode to the imaging mode. The vertical scanning circuit 2 controls the control signal RES from the low level to the high level for the pixels 11 in the (N+1)th row to be read next. As a result, the reset signal N is output from each pixel 11 in the (N+1)th row.

At time t23e, the horizontal scanning circuit 6 starts a dummy transfer operation of transferring the dummy signal Dm from the memory 52 to the signal processing circuit 7.

At time t24e, the horizontal scanning circuit 6 ends the dummy transfer operation of transferring the dummy signal Dm. As described above, the horizontal scanning circuit 6 transfers the dummy signal Dm from the time t23e to the time t24e.

From time t25e to time t26e, the column signal processing circuit 5 performs AD conversion on the reset signal N output from each pixel 11 in the (N+1)th row and stores the reset signal N after AD conversion in the memory 52.

At time t27e, the horizontal scanning circuit 6 starts an operation of transferring the imaging pixel signal S2 of the Nth row from the memory 52 to the signal processing circuit 7.

At time t28e, the vertical scanning circuit 2 controls the control signals TX_1 and TX_2 from the low level to the high level for the pixels 11 in the (N+1)th row. As a result, the imaging pixel signal S is output from each pixel 11 in the (N+1)th row.

At time t29e, the horizontal scanning circuit 6 ends the operation of transferring the imaging pixel signal S2 of the Nth row. As described above, the horizontal scanning circuit 6 transfers the imaging pixel signal S2 of the Nth row from the time t27e to the time t29e.

From time t30e to time t31e, the column signal processing circuit 5 performs AD conversion on the imaging pixel signal S output from each pixel 11 in the (N+1)th row and stores the imaging pixel signal S after AD conversion in the memory 52.

At time t32e, the vertical scanning circuit 2 controls the control signal RES from the low level to the high level for the pixels 11 in the (N+2)th row to be read next. As a result, the reset signal N is output from each pixel 11 in the (N+2)th row.

At time t33e, the horizontal scanning circuit 6 starts an operation of transferring the reset signal Na of the (N+1)th row from the memory 52 to the signal processing circuit 7.

At time t34e, the horizontal scanning circuit 6 ends the operation of transferring the reset signal Na of the (N+1)th row. As described above, the horizontal scanning circuit 6 transfers the reset signal Na of the (N+1)th row from the time t33e to the time t34e.

From time t35e to time t36e, the column signal processing circuit 5 performs AD conversion on the reset signal N output from each pixel 11 in the (N+2)th row and stores the reset signal N after AD conversion in the memory 52.

At time t37e, the horizontal scanning circuit 6 starts an operation of transferring the reset signal Nb of the (N+1)th row from the memory 52 to the signal processing circuit 7.

At time t38e, the horizontal scanning circuit 6 ends the operation of transferring the reset signal Nb of the (N+1)th row. As described above, the horizontal scanning circuit 6 transfers the reset signal Nb of the (N+1)th row from the time t37e to the time t38e.

At time t39e, the horizontal scanning circuit 6 starts an operation of transferring the imaging pixel signal S of the (N+1)th row from the memory 52 to the signal processing circuit 7.

At time t40c, the vertical scanning circuit 2 controls the control signals TX_1 and TX_2 from the low level to the high level for the pixels 11 in the (N+2)th row. As a result, the imaging pixel signal S is output from each pixel 11 in the (N+2)th row.

At time t41e, the horizontal scanning circuit 6 ends the operation of transferring the imaging pixel signal S of the (N+1)th row. As described above, the horizontal scanning circuit 6 transfers the imaging pixel signal S of the (N+1)th row from the time t39e to the time t41c.

From time t42e to time t43e, the column signal processing circuit 5 performs AD conversion on the imaging pixel signal S output from each pixel 11 in the (N+2)th row and stores the imaging pixel signal S after AD conversion in the memory 52.

At time t44c, the vertical scanning circuit 2 controls the control signal RES from the low level to the high level for the pixels 11 in the (N+3)th row to be read next. As a result, the reset signal N is output from each pixel 11 in the (N+3)th row.

As described above, the horizontal scanning circuit 6 transfers the dummy signal Dm in the transfer period (time t23e to t24e). The transfer period (time t23e to t24c) is a period different from the AD conversion period and is positioned between the AD conversion period (time t20e to t21e) of the Nth row and the AD conversion period (time t25c to t26c) of the (N+1)th row.

According to the imaging device 100 according to the present embodiment, in the case of transition from the AF imaging mode to the imaging mode, in the imaging mode, the dummy transfer operation is performed so that the number of times of the signal transfer operation is the same in each scan in the imaging mode. Here, the number of signal transfer operations is, for example, the number of signal transfer operations between the AD conversion period (time t25e to t26e) and the AD conversion period (time t20c to t21e) immediately before the AD conversion period (time t25e to t26e). The number of signal transfer operations is the number of signal transfer operations between the AD conversion period (time t35e to t36e) and the AD conversion period (time t30e to t31e) immediately before the AD conversion period (time t35e to t36c).

Accordingly, the imaging device 100 can make the number of signal transfer operations the same between the first AD conversion period and the AD conversion period immediately before the first AD conversion period in each scan in the imaging mode. As a result, noise due to power supply fluctuation at the time of performing the signal transfer operation similarly affects the AD conversion processing in each AD conversion period. Accordingly, the noise of the imaging pixel signal S2 can be accurately removed by using the reset signal N_AF.

### Fifth Comparative Example

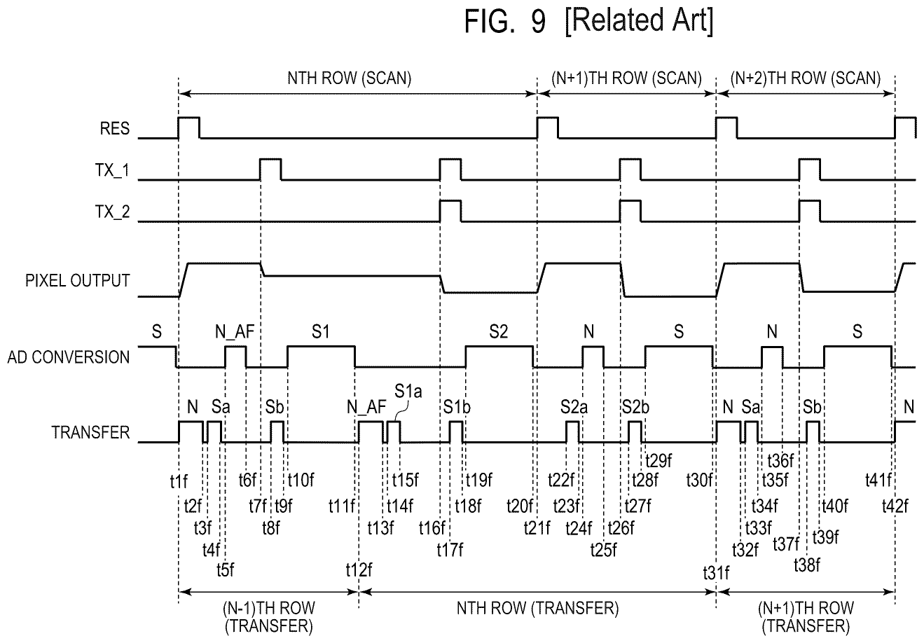

FIG. 9 is a timing chart of an imaging device according to a fifth comparative example. In FIG. 9, similarly to FIG. 6, an example of transition from the AF imaging mode to the imaging mode will be described. In this example, the focus detection pixel signal S1 and the imaging pixel signal S2 are respectively divided into two parts (focus detection pixel signals S1a and S1b, imaging pixel signals S2a and S2b) for transmission.

At time t1f, the vertical scanning circuit 2 scans the pixels 11 in the AF imaging mode. The vertical scanning circuit 2 controls the control signal RES from the low level to the high level for the pixels 11 in the row (Nth row) to be read. The reset transistor M3 is turned on, and the input node FD is reset to a voltage corresponding to the voltage VDD. As a result, the reset signal is output from each pixel 11 in the Nth row.

At time t1f, the horizontal scanning circuit 6 starts an operation of transferring the reset signal N of the (N−1)th row from the memory 52 to the signal processing circuit 7.

At time t2f, the horizontal scanning circuit 6 ends the operation of transferring the reset signal N of the (N−1)th row.

At time t3f, the horizontal scanning circuit 6 starts an operation of transferring the imaging pixel signal Sa of the (N−1)th row from the memory 52 to the signal processing circuit 7.

At time t4f, the horizontal scanning circuit 6 ends the operation of transferring the imaging pixel signal Sa of the (N−1)th row.

From time t5f to time t6f, the column signal processing circuit 5 performs AD conversion on the reset signal N_AF output from each pixel 11 in the Nth row and stores the reset signal N_AF after AD conversion in the memory 52.

At time t7f, the vertical scanning circuit 2 controls the control signal TX_1 from the low level to the high level for the pixels 11 in the Nth row. The transfer transistor M1 is turned on, and the signal charge held in the photoelectric conversion element PD1 is transferred to the input node FD. As a result, the focus detection pixel signal S1 is output from each pixel 11 in the Nth row.

At time t8f, the horizontal scanning circuit 6 starts an operation of transferring the imaging pixel signal Sb of the (N−1)th row from the memory 52 to the signal processing circuit 7.

At time t9f, the horizontal scanning circuit 6 ends the operation of transferring the imaging pixel signal Sb of the (N−1)th row.

From time t10f to time t11f, the column signal processing circuit 5 performs AD conversion on the focus detection pixel signal S1 output from each pixel 11 in the Nth row and stores the focus detection pixel signal S1 after AD conversion in the memory 52.

At time t12f, the horizontal scanning circuit 6 starts an operation of transferring the reset signal N_AF of the Nth row from the memory 52 to the signal processing circuit 7.

At time t13f, the horizontal scanning circuit 6 ends the operation of transferring the reset signal N_AF of the Nth row. In this way, the horizontal scanning circuit 6 transfers the reset signal N_AF of the Nth row from the time t12f to the time t13f.

At time t14f, the horizontal scanning circuit 6 starts an operation of transferring the focus detection pixel signal S1a of the Nth row from the memory 52 to the signal processing circuit 7.

At time t15f, the horizontal scanning circuit 6 ends the operation of transferring the focus detection pixel signal S1a of the Nth row. As described above, the horizontal scanning circuit 6 transfers the focus detection pixel signal S1a in the Nth row from the time t14f to the time t15f.

At time t16f, the vertical scanning circuit 2 controls the control signals TX_1 and TX_2 from the low level to the high level for the pixels 11 in the Nth row. The transfer transistors M1 and M2 are turned on, and the signal charges held in the photoelectric conversion elements PD1 and PD2 are transferred to the input node FD. As a result, the imaging pixel signal S2 is output from each pixel 11 in the Nth row.

At time t17f, the horizontal scanning circuit 6 starts an operation of transferring the focus detection pixel signal S1b of the Nth row from the memory 52 to the signal processing circuit 7.

At time t18f, the horizontal scanning circuit 6 ends the operation of transferring the focus detection pixel signal S1b of the Nth row. As described above, the horizontal scanning circuit 6 transfers the focus detection pixel signal S1b of the Nth row at the time t17f to t18f.

From time t19f to time t20f, the column signal processing circuit 5 performs AD conversion on the imaging pixel signal S2 output from each pixel 11 in the Nth row and stores the imaging pixel signal S2 after AD conversion in the memory 52.

At time t21f, the vertical scanning circuit 2 transitions from the AF imaging mode to the imaging mode. The vertical scanning circuit 2 controls the control signal RES from the low level to the high level for the pixels 11 in the (N+1)th row to be read next. As a result, the reset signal N is output from each pixel 11 in the (N+1)th row.

At time t22f, the horizontal scanning circuit 6 starts an operation of transferring the imaging pixel signal S2a of the Nth row from the memory 52 to the signal processing circuit 7.

At time t23f, the horizontal scanning circuit 6 ends the operation of transferring the imaging pixel signal S2a of the Nth row. As described above, the horizontal scanning circuit 6 transfers the imaging pixel signal S2a of the Nth row in the period from the time t22f to the time t23f.

From time t24f to time t25f, the column signal processing circuit 5 performs AD conversion on the reset signal N output from each pixel 11 in the (N+1)th row and stores the reset signal N after AD conversion in the memory 52.

At time t26f, the vertical scanning circuit 2 controls the control signals TX_1 and TX_2 from the low level to the high level for the pixels 11 in the (N+1)th row. As a result, the imaging pixel signal S is output from each pixel 11 in the (N+1)th row.

At time t27f, the horizontal scanning circuit 6 starts an operation of transferring the imaging pixel signal S2b of the Nth row from the memory 52 to the signal processing circuit 7.

At time t28f, the horizontal scanning circuit 6 ends the operation of transferring the imaging pixel signal S2b of the Nth row. As described above, the horizontal scanning circuit 6 transfers the imaging pixel signal S2b of the Nth row from the time t27f to the time t28f.

From time t29f to time t30f, the column signal processing circuit 5 performs AD conversion on the imaging pixel signal S output from each pixel 11 in the (N+1)th row and stores the imaging pixel signal S after AD conversion in the memory 52.

At time t31f, the vertical scanning circuit 2 controls the control signal RES from the low level to the high level for the pixels 11 in the (N+2)th row to be read next. As a result, the reset signal N is output from each pixel 11 in the (N+2)th row.

At time t31f, the horizontal scanning circuit 6 starts an operation of transferring the reset signal N of the (N+1)th row from the memory 52 to the signal processing circuit 7.

At time t32f, the horizontal scanning circuit 6 ends the operation of transferring the reset signal N of the (N+1)th row. As described above, the horizontal scanning circuit 6 transfers the reset signal N of the (N+1)th row from the time t31f to the time t32f.

At time t33f, the horizontal scanning circuit 6 starts an operation of transferring the imaging pixel signal Sa of the (N+1)th row from the memory 52 to the signal processing circuit 7.

At time t34f, the horizontal scanning circuit 6 ends the operation of transferring the imaging pixel signal Sa of the (N+1)th row. As described above, the horizontal scanning circuit 6 transfers the imaging pixel signal Sa of the (N+1)th row from the time t33f to the time t34f.

From time t35f to time t36f, the column signal processing circuit 5 performs AD conversion on the reset signal N output from each pixel 11 in the (N+2)th row and stores the reset signal N after AD conversion in the memory 52.

At time t37f, the vertical scanning circuit 2 controls the control signals TX_1 and TX_2 from the low level to the high level for the pixels 11 in the (N+2)th row. As a result, the imaging pixel signal S is output from each pixel 11 in the (N+2)th row.

At time t38f, the horizontal scanning circuit 6 starts an operation of transferring the imaging pixel signal Sb of the (N+1)th row from the memory 52 to the signal processing circuit 7.

At time t39f, the horizontal scanning circuit 6 ends the operation of transferring the imaging pixel signal Sb of the (N+1)th row. In this way, the horizontal scanning circuit 6 transfers the imaging pixel signal Sb of the (N+1)th row from the time t38f to the time t39f.

From time t40f to time t41f, the column signal processing circuit 5 performs AD conversion on the imaging pixel signal S output from each pixel 11 in the (N+2)th row and stores the imaging pixel signal S after AD conversion in the memory 52.

At time t42f, the vertical scanning circuit 2 controls the control signal RES from the low level to the high level for the pixels 11 in the (N+3)th row to be read next. As a result, the reset signal N is output from each pixel 11 in the (N+3)th row.

As described above, the horizontal scanning circuit 6 transfers the signals (reset signal N_AF, two-divided focus detection pixel signals S1a and S1b, and two-divided imaging pixel signals S2a and S2b) output from each pixel 11 in the Nth row between the AD conversion periods. Further, the horizontal scanning circuit 6 transfers the signals (reset signal N, two-divided imaging pixel signals Sa and Sb) output from each pixel 11 in the (N+1)th row to the signal processing circuit 7 between the AD conversion periods.

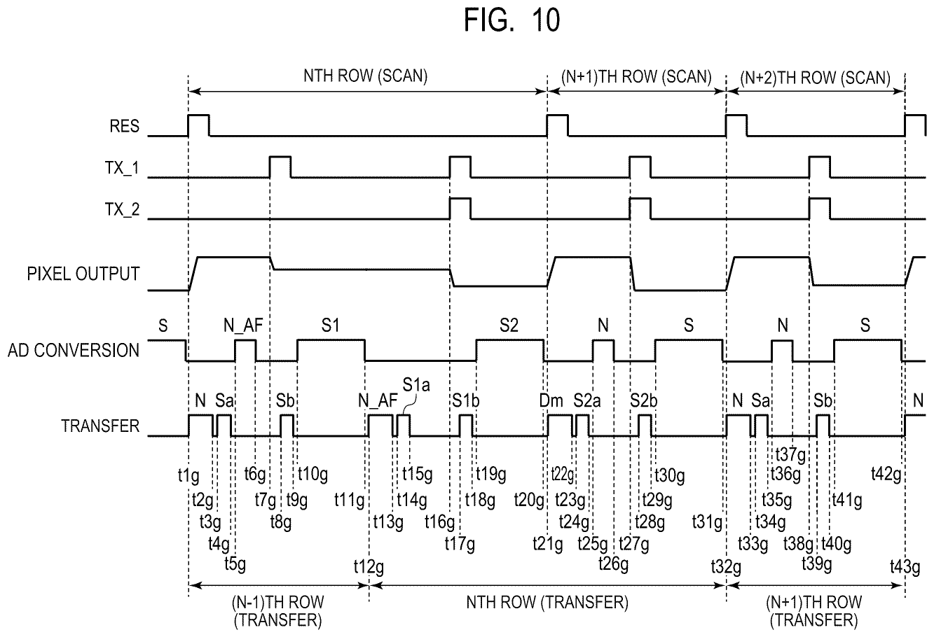

Before AD conversion of each signal, a signal transfer operation is performed at least once. However, the number of signal transfer operations is different between the AD conversion periods. For example, one signal transfer operation is included between the AD conversion period of the Nth row (time t19f to t20f) and the AD conversion period of the (N+1)th row (time t24f to t25f). On the other hand, two signal transfer operations are included between the AD conversion period of the (N+1)th row (time t29f to t30f) and the AD conversion period of the (N+2)th row (time t35f to t36f). As described above, when the number of times of the signal transfer operation is different, the influence of the noise due to the power supply fluctuation when the signal transfer operation is performed may be different depending on the AD conversion processing. In particular, when the number of signal transfer lines increases and the peak current in the signal transfer further increases, not only the power supply fluctuation in the signal transfer operation immediately before the AD conversion but also the influence of the power supply fluctuation in the signal transfer operation before the AD conversion cannot be ignored. Therefore, the imaging device according to the present comparative example has a problem that noise cannot be accurately removed. A method of solving this problem will be described with reference to FIG. 10.

### Third Embodiment

FIG. 10 is a timing chart of the imaging device 100 according to the present embodiment. In FIG. 10, similarly to FIG. 9, an example of transition from the AF imaging mode to the imaging mode will be described. Then, the focus detection pixel signal S1 and the imaging pixel signal S2 are respectively divided into two parts (focus detection pixel signals S1a and S1b, imaging pixel signals S2a and S2b) for transmission.

The process from time t1g to time t20g is the same as the process from time t1f to time t20f in FIG. 9.

At time t21g, the horizontal scanning circuit 6 starts the dummy transfer operation of transferring the dummy signal Dm from the memory 52 to the signal processing circuit 7.

At time t22g, the horizontal scanning circuit 6 ends the dummy transfer operation of transferring the dummy signal Dm. As described above, the horizontal scanning circuit 6 transfers the dummy signal Dm from the time t21g to the time t22g.

The process from time t23g to time t43g is the same as the process from time t22f to time t42f in FIG. 9.

As described above, the horizontal scanning circuit 6 transfers the dummy signal Dm in the transfer period (time t21g to t22g). The transfer period (time t21g to time t22g) is a period different from the AD conversion period and is positioned between the AD conversion period of the Nth row (time t19g to time t20g) and the AD conversion period of the (N+1)th row (time t25g to time t26g).

In the imaging device 100 according to the present embodiment, when a transition is made from the AF imaging mode to the imaging mode, the dummy transfer operation is performed so that the number of times of the signal transfer operation is the same in each scan in the imaging mode. Here, the number of signal transfer operations is, for example, the number of signal transfer operations between the AD conversion period (time t25g to t26g) and the AD conversion period (time t19g to t20g) immediately before the AD conversion period (time t25g to t26g). The number of signal transfer operations is the number of signal transfer operations between the AD conversion period (time t36g to t37g) and the AD conversion period (time t30g to t31g) immediately before the AD conversion period (time t36g to t37g). This makes it possible to match the number of signal transfer operations (two times). Therefore, the influence of noise on each AD conversion process can be made more equal, and noise can be removed more accurately.

The period from the end of the plurality of signal transfer operations to the start of the AD conversion period (time t25g to t26g, time t36g to t37g) is the same in each scan in the imaging mode. As a result, noise can be removed more accurately.

### Fourth Embodiment

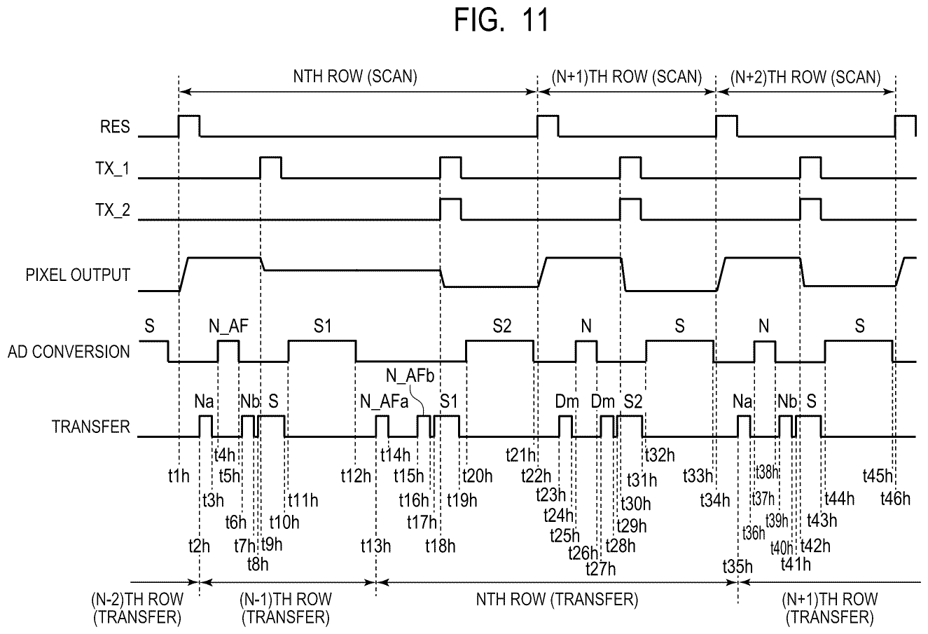

FIG. 11 is a timing chart of the imaging device 100 according to the present embodiment. In FIG. 11, an example in which the accuracy of noise removal is further improved with respect to the processing described with reference to FIG. 8 will be described.

In FIG. 8, the dummy transfer operation is performed so that the number of signal transfer operations is the same in each scan in the imaging mode. Here, the number of signal transfer operations is between the AD conversion period (time t25e to t26e) and the AD conversion period (time t20e to t21e) immediately before the AD conversion period (time t25e to t26e).

In FIG. 11, in addition to this, the dummy transfer operation is performed so that the number of signal transfer operations in another AD conversion period is also the same in each scan in the imaging mode. Here, the number of signal transfer operations in another AD conversion period is between the AD conversion period (time t25e to t26e) and the AD conversion period (time t30e to t31e) next to the AD conversion period (time t25e to t26e). This will be described in detail below.

The process from time t1h to time t26h is the same as the process from time t1e to time t26e in FIG. 8.

At time t27h, the horizontal scanning circuit 6 starts the dummy transfer operation of transferring the dummy signal Dm from the memory 52 to the signal processing circuit 7.

At time t28h, the horizontal scanning circuit 6 ends the dummy transfer operation of transferring the dummy signal Dm. As described above, the horizontal scanning circuit 6 transfers the dummy signal Dm from the time t27h to the time t28h.

The process from time t29h to time t46h is the same as the process from time t27e to time t44e in FIG. 8.

As described above, the horizontal scanning circuit 6 transfers the dummy signal Dm also in the transfer period (time t27h to t28h). The transfer period (time t27h to t28h) is a period different from the AD conversion period and is positioned between the AD conversion period (time t25h to t26h) of the (N+1)th row and the AD conversion period (time t32h to t33h) of the (N+1)th row.

In the imaging device 100 according to the present embodiment, when a transition is made from the AF imaging mode to the imaging mode, the horizontal scanning circuit 6 performs the dummy transfer operation so that the number of times of the signal transfer operation is the same in each scan in the imaging mode. Here, the number of signal transfer operations is between the AD conversion period (time t25h to t26h) and the AD conversion period (time t20h to t21h) immediately before the AD conversion period (time t25h to t26h).

Further, the horizontal scanning circuit 6 performs the dummy transfer operation so that the number of signal transfer operations in another AD conversion period is also the same in each scan in the imaging mode. Here, the number of signal transfer operations is between the AD conversion period (time t25h to t26h) and the AD conversion period (time t32h to t33h) next to the AD conversion period (time t25h to t26h).

Accordingly, the number of times (two times) of the first signal transfer operation and the number of times (two times) of the second signal transfer operation are the same. Here, the number of times (two times) of the first signal transfer operation is between the AD conversion period (times t25h to t26h) of the (N+1)th row and the AD conversion period (times t32h to t33h) of the (N+1)th row. The number of times (two times) of the second signal transfer operation is between the AD conversion period (times t37h to t38h) of the (N+2)th row and the AD conversion period (times t44h to t45h) of the (N+2)th row. As compared with the processing described in FIG. 8, it is possible to make the influence of noise on each AD conversion processing more equal, and it is possible to remove noise more accurately.

The period from the end of the plurality of first signal transfer operations to the start of the AD conversion period (time t32h to t33h) of the (N+1)th row may be the same as the period from the end of the plurality of second signal transfer operations to the start of the AD conversion period (time t44h to t45h) of the (N+2)th row. As described above, the period from the end of a plurality of signal transfer operations to the start of the AD conversion period is the same in each scan in the imaging mode. As a result, noise can be removed more accurately.

### Fifth Embodiment

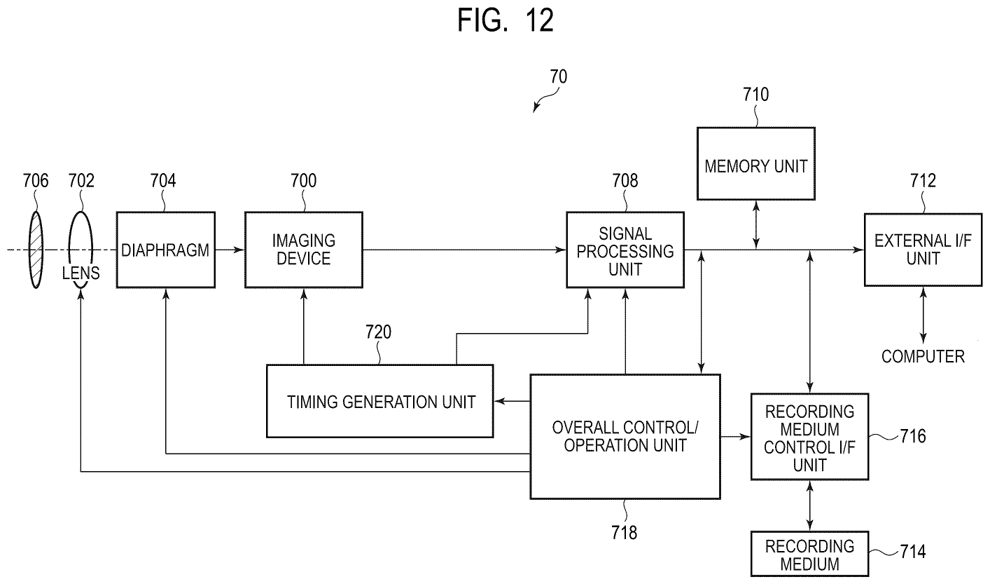

The imaging device according to the above-described embodiment can be applied to various devices. Examples of the device include a digital still camera, a digital camcorder, a camera head, a copier, a fax machine, a mobile phone, an in-vehicle camera, an observation satellite, and a monitoring camera. FIG. 12 is a block diagram of a digital still camera as an example of the equipment.

The device 70 illustrated in FIG. 12 includes a barrier 706, a lens 702, a diaphragm 704, and an imaging device 700 of the above-described embodiment. The device 70 further includes a signal processing unit (processing device) 708, a timing generation unit 720, an overall control/operation unit 718 (control device), a memory unit 710 (storage device), a recording medium control I/F unit 716, a recording medium 714, and an external I/F unit 712. At least one of the barrier 706, the lens 702, and the diaphragm 704 is an optical device corresponding to the device. The barrier 706 protects the lens 702, and the lens 702 forms an optical image of a subject on the imaging device 700. The diaphragm 704 makes the amount of light passing through the lens 702 variable. The imaging device 700 is configured as in the above-described embodiment, and converts an optical image formed by the lens 702 into image data (image signal). The signal processing unit 708 performs various corrections, data compression, and the like on the imaging data output from the imaging device 700. The timing generation unit 720 outputs various timing signals to the imaging device 700 and the signal processing unit 708. The overall control/operation unit 718 controls the entire digital still camera, and the memory unit 710 temporarily stores image data. The recording medium control I/F unit 716 is an interface for recording or reading image data on or from the recording medium 714, and the recording medium 714 is a detachable recording medium such as a semiconductor memory for recording or reading imaging data. The external I/F unit 712 is an interface for communicating with an external computer or the like. The timing signal and the like may be input from the outside of the device. The device 70 may further include a display device (a monitor, an electronic viewfinder, or the like) that displays information obtained by the imaging device 700. Further, the device 70 includes at least one of an optical device, a control device, a processing device, a display device, a storage device, and a mechanical device that operates based on information obtained by the imaging device 700. The mechanical device is a movable unit (for example, a robot arm) that operates by receiving a signal from the imaging device 700.

### Sixth Embodiment

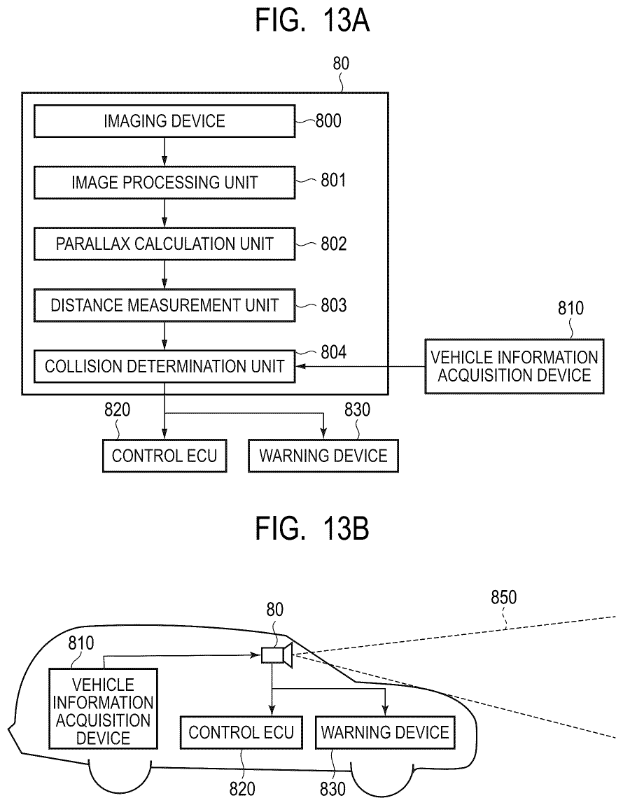

FIGS. 13A and 13B are block diagrams of equipment related to the in-vehicle camera according to the present embodiment. The device 80 includes an imaging device 800 of the above-described embodiment and a signal processing device that processes a signal from the imaging device 800. The device 80 includes an image processing unit 801 that performs image processing on a plurality of pieces of image data acquired by the imaging device 800, and a parallax calculation unit 802 that calculates parallax (phase difference of parallax images) from the plurality of pieces of image data acquired by the device 80. In addition, the device 80 includes a distance measurement unit 803 that calculates a distance to an object based on the calculated parallax, and a collision determination unit 804 that determines whether there is a possibility of collision based on the calculated distance. Here, the parallax calculation unit 802 and the distance measurement unit 803 are examples of a distance information acquisition unit that acquires distance information to an object. That is, the distance information is information related to a parallax, a defocus amount, a distance to an object, and the like. The collision determination unit 804 may determine the collision possibility using any of these pieces of distance information. The distance information acquisition unit may be realized by dedicatedly designed hardware or may be realized by a software module. Also, it may be realized by FPGA (Field Programmable Gate Array), ASIC (Application Specific Integrated Circuit) or a combination thereof.

The device 80 is connected to the vehicle information acquisition device 810 and can acquire vehicle information such as a vehicle speed, a yaw rate, and a steering angle. In addition, a control ECU 820, which is a control device that outputs a control signal for generating a braking force to the vehicle based on the determination result of the collision determination unit 804, is connected to the device 80. The device 80 is also connected to a warning device 830 that issues a warning to the driver based on the determination result of the collision determination unit 804. For example, when the determination result of the collision determination unit 804 indicates that the possibility of collision is high, the control ECU 820 performs vehicle control to avoid collision and reduce damage by, for example, applying a brake, returning an accelerator, or suppressing engine output. The warning device 830 gives a warning to the user by sounding a warning such as a sound, displaying warning information on a screen of a car navigation system or the like, giving vibration to a seat belt or a steering wheel, or the like. The device 80 functions as a control unit that controls the operation of controlling the vehicle as described above.

In the present embodiment, the surroundings of the vehicle, for example, the front or the rear is imaged by the device 80. FIG. 13B illustrates a device in a case of capturing an image in front of the vehicle (imaging range 850). The vehicle information acquisition device 810 serving as the imaging control unit sends an instruction to the device 80 or the imaging device 800 to perform the imaging operation. With such a configuration, the accuracy of distance measurement can be further improved.

In the above description, an example in which control is performed so as not to collide with another vehicle has been described, but the present invention is also applicable to control in which automatic driving is performed so as to follow another vehicle, control in which automatic driving is performed so as not to protrude from a lane, and the like. Furthermore, the device is not limited to vehicles such as automobiles, and can be applied to, for example, ships, aircrafts, artificial satellites, industrial robots, consumer robots, and the like mobile object (mobile devices). In addition, the present invention is not limited to mobile object and can be widely applied to devices utilizing object recognition or biological recognition, such as an intelligent traffic system (ITS) and a monitoring system.

### Modified Embodiments

The present disclosure is not limited to the above embodiment, and various modifications are possible. For example, an example in which a part of the configuration of any of the embodiments is added to another embodiment or an example in which a part of the configuration of another embodiment is replaced with another embodiment is also an embodiment of the present disclosure.

In FIGS. 7, 8, and 10, an example in which the number of times of the dummy transfer operation is performed once in one scanning (one scanning) is described, and in FIG. 11, an example in which the number of times of the dummy transfer operation is performed a plurality of times in one scanning (one scanning) is described. As described above, the number of times of performing the dummy transfer operation in one scanning (one scanning) is not limited.

In the example illustrated in FIG. 7, the number of times of the first signal transfer operation and the number of times of the second signal transfer operation are each one. Here, the number of times of the first signal transfer operation is between the AD conversion period of the (N+1)th row (time t25d to t26d) and the AD conversion period of the (N+2)th row (time t30d to t31d). The number of times of the second signal transfer operation is between the AD conversion period (time t30d to t31d) of the (N+2)th row and the AD conversion period (time t35d to t36d) of the (N+2)th row. The number of times of the first signal transfer operation and the number of times of the second signal transfer operation may be plural. In this case, the number of times of the first signal transfer operation and the number of times of the second signal transfer operation may be the same. The period from the end of the plurality of first signal transfer operations to the start of the AD conversion period (time t30d to t31d) of the (N+2)th row may be the same as the period from the end of the plurality of second signal transfer operations to the start of the AD conversion period (time t35d to t36d) of the (N+2)th row.

In the example illustrated in FIG. 8, the number of times of the first signal transfer operation and the number of times of the second signal transfer operation are each one. Here, the number of times of the first signal transfer operation is between the AD conversion period (time t25e to t26c) and the AD conversion period (time t20e to t21e) immediately before the AD conversion period. The number of times of the second signal transfer operation is between the AD conversion period (time t35e to t36e) and the AD conversion period (time t30e to t31e) immediately before the AD conversion period. The number of times of the first signal transfer operation and the number of times of the second signal transfer operation may be a plurality of times. In this case, the number of times of the first signal transfer operation and the number of times of the second signal transfer operation may be the same.

In FIG. 10, an example in which the period from the end of a plurality of signal transfer operations to the start of the AD conversion period (time t25g to t26g, time t36g to t37g) is the same in each scan in the imaging mode has been described, but the period is the same in one signal transfer operation. That is, the period from the end of one signal transfer operation to the start of the AD conversion period (time t25g to t26g, time t36g to t37g) is the same in each scan in the imaging mode.

In FIG. 11, an example in which the period from the end of a plurality of signal transfer operations to the start of the AD conversion period (time t32h to t33h, time t44h to t45h) is the same in each scan in the imaging mode has been described, but the period is the same in one signal transfer operation. That is, the period from the end of one signal transfer operation to the start of the AD conversion period (time t32h to t33h, time t44h to t45h) is the same in each scan in the imaging mode.

In the first to fourth embodiments described above, a configuration in which a plurality of photoelectric conversion units are provided for one microlens ML has been described, but the present invention is not limited to this configuration. That is, one photoelectric conversion unit may be provided corresponding to one microlens ML. In this case, it can be considered that one pixel includes two microlenses ML. That is, in the configuration of the present specification, the plurality of photoelectric conversion units are included in each of the plurality of pixels. The first scanning circuit included in the photoelectric conversion device operates in a first mode in which an analog signal of a reset level and an analog signal corresponding to signal charges of both the first photoelectric conversion unit and the second photoelectric conversion unit are output. In addition, the first scanning circuit operates in a second mode in which an analog signal of a reset level, an analog signal corresponding to signal charges of the first photoelectric conversion unit, and an analog signal corresponding to signal charges of both the first photoelectric conversion unit and the second photoelectric conversion unit are output. The first to fourth embodiments of the present specification can be applied to a photoelectric conversion device having such a configuration.

According to the present disclosure, it is possible to realize a photoelectric conversion device capable of accurately removing noise.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-115752, filed Jul. 19, 2024, which is hereby incorporated by reference herein in its entirety.

What is claimed is:

1. A photoelectric conversion device comprising:
a plurality of pixels each including a first photoelectric conversion unit and a second photoelectric conversion unit each of which generates a signal charge;
a first scanning circuit configured to scan the plurality of pixels in a first mode for outputting an analog signal of a reset level and an analog signal corresponding to the signal charges of both the first photoelectric conversion unit and the second photoelectric conversion unit from the pixel, and a second mode for outputting the analog signal of the reset level, an analog signal corresponding to the signal charge of the first photoelectric conversion unit, and the analog signal corresponding to the signal charges of both the first photoelectric conversion unit and the second photoelectric conversion unit from the pixel;
an analog-to-digital conversion unit configured to convert each of analog signals into a digital signal in a plurality of analog-to-digital conversion periods;
a memory configured to hold the digital signal; and
a second scanning circuit configured to perform a signal transfer operation for outputting the digital signal from the memory in each of a plurality of transfer periods different from the plurality of analog-to-digital conversion periods,
wherein the plurality of analog-to-digital conversion periods include a first analog-to-digital conversion period for converting the analog signal of the reset level in the first mode into the digital signal, and
wherein when transitioning from the second mode to the first mode, the second scanning circuit performs an additional signal transfer operation so that the number of times of a first signal transfer operation between the first analog-to-digital conversion period and the analog-to-digital conversion period immediately before the first analog-to-digital conversion period is equal to the number of times of a second signal transfer operation between the first analog-to-digital conversion period and the analog-to-digital conversion period next to the first analog-to-digital conversion period.

2. The photoelectric conversion device according to claim 1, wherein a period from an end of the first signal transfer operation to a start of the first analog-to-digital conversion period is the same as a period from an end of the second signal transfer operation to a start of the analog-to-digital conversion period next to the first analog-to-digital conversion period.

3. The photoelectric conversion device according to claim 1,
wherein the number of times of the first signal transfer operation and the number of times of the second signal transfer operation are each plural, and
wherein a period from an end of a plurality of the first signal transfer operations to a start of the first analog-to-digital conversion period is the same as a period from an end of a plurality of the second signal transfer operations to a start of the analog-to-digital conversion period next to the first analog-to-digital conversion period.

4. A photoelectric conversion device comprising:
a plurality of pixels each including a first photoelectric conversion unit and a second photoelectric conversion unit each of which generates a signal charge;
a first scanning circuit configured to scan the plurality of pixels in a first mode for outputting an analog signal of a reset level and an analog signal corresponding to the signal charges of both the first photoelectric conversion unit and the second photoelectric conversion unit from the pixel, and a second mode for outputting the analog signal of the reset level, an analog signal corresponding to the signal charge of the first photoelectric conversion unit, and the analog signal corresponding to the signal charges of both the first photoelectric conversion unit and the second photoelectric conversion unit from the pixel;
an analog-to-digital conversion unit configured to convert each of analog signals into a digital signal in a plurality of analog-to-digital conversion periods;
a memory configured to hold the digital signal; and
a second scanning circuit configured to perform a signal transfer operation for outputting the digital signal from the memory in each of a plurality of transfer periods different from the plurality of analog-to-digital conversion periods,
wherein the plurality of analog-to-digital conversion periods include a first analog-to-digital conversion period for converting the analog signal of the reset level in the first mode into the digital signal, and
wherein when transitioning from the second mode to the first mode, the second scanning circuit performs an additional signal transfer operation so that the number of times of a first signal transfer operation between the first analog-to-digital conversion period and the analog-to-digital conversion period immediately before the first analog-to-digital conversion period is the same for each scan in the first mode.

5. The photoelectric conversion device according to claim 4, wherein a period from an end of the first signal transfer operation to a start of the first analog-to-digital conversion period is the same for each scan in the first mode.

6. The photoelectric conversion device according to claim 4,
wherein the number of times of the first signal transfer operation is plural, and
wherein a period from an end of a plurality of the first signal transfer operations to a start of the first analog-to-digital conversion period is the same for each scan in the first mode.

7. A photoelectric conversion device comprising:
a plurality of pixels each including a first photoelectric conversion unit and a second photoelectric conversion unit each of which generates a signal charge;
a first scanning circuit configured to scan the plurality of pixels in a first mode for outputting an analog signal of a reset level and an analog signal corresponding to the signal charges of both the first photoelectric conversion unit and the second photoelectric conversion unit from the pixel, and a second mode for outputting the analog signal of the reset level, an analog signal corresponding to the signal charge of the first photoelectric conversion unit, and the analog signal corresponding to the signal charges of both the first photoelectric conversion unit and the second photoelectric conversion unit from the pixel;
an analog-to-digital conversion unit configured to convert each of analog signals into a digital signal in a plurality of analog-to-digital conversion periods;
a memory configured to hold the digital signal; and
a second scanning circuit configured to perform a signal transfer operation for outputting the digital signal from the memory in each of a plurality of transfer periods different from the plurality of analog-to-digital conversion periods,
wherein the plurality of analog-to-digital conversion periods include a first analog-to-digital conversion period for converting the analog signal of the reset level in the first mode into the digital signal, and
wherein when transitioning from the second mode to the first mode, the second scanning circuit performs an additional signal transfer operation so that the number of times of a first signal transfer operation between the first analog-to-digital conversion period and the analog-to-digital conversion period next to the first analog-to-digital conversion period is the same for each scan in the first mode.

8. The photoelectric conversion device according to claim 7, wherein a period from an end of the first signal transfer operation to a start of the analog-to-digital conversion period next to the first analog-to-digital conversion period is the same for each scan in the first mode.

9. The photoelectric conversion device according to claim 7,
wherein the number of times of the first signal transfer operation is plural, and
wherein a period from an end of a plurality of the first signal transfer operations to a start of the analog-to-digital conversion period next to the first analog-to-digital conversion period is the same for each scan in the first mode.

10. The photoelectric conversion device according to claim 1, wherein the number of the additional signal transfer operation is one in one scan.

11. The photoelectric conversion device according to claim 1, wherein the number of the additional signal transfer operations is a plurality of times in one scan.

12. The photoelectric conversion device according to claim 1, wherein the additional signal transfer operation outputs a dummy signal different from the digital signal.

13. The photoelectric conversion device according to claim 1, wherein the first scanning circuit intermittently scans in the second mode during scanning in the first mode.

14. The photoelectric conversion device according to claim 1, wherein the first photoelectric conversion unit and the second photoelectric conversion unit are provided for one microlens.

15. An equipment comprising:
the photoelectric conversion device according to claim 1; and
at least one of:
an optical device corresponding to the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device; and
a mechanical device configured to operate based on information obtained by the photoelectric conversion device.

16. The equipment according to claim 15, wherein the processing device acquires distance information from the photoelectric conversion device to an object.

17. An equipment comprising:
the photoelectric conversion device according to claim 4; and
at least one of:
an optical device corresponding to the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device; and
a mechanical device configured to operate based on information obtained by the photoelectric conversion device.

18. The equipment according to claim 17, wherein the processing device acquires distance information from the photoelectric conversion device to an object.

19. An equipment comprising:
the photoelectric conversion device according to claim 7; and
at least one of:
an optical device corresponding to the photoelectric conversion device,
a control device configured to control the photoelectric conversion device,
a processing device configured to process a signal output from the photoelectric conversion device,
a display device configured to display information obtained by the photoelectric conversion device,
a storage device configured to store information obtained by the photoelectric conversion device; and
a mechanical device configured to operate based on information obtained by the photoelectric conversion device.

20. The equipment according to claim 19, wherein the processing device acquires distance information from the photoelectric conversion device to an object.
